(19) United States
(12) Patent Application Publication
(10) Pub. No.: US 2006/0203294 A1
(43) Pub. Date: Sep. 14, 2006

(54) Layout processing method, information processing apparatus, and computer program

(75) Inventor: Jun Makino, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/366,441

(22) Filed: Mar. 3, 2006

(30) Foreign Application Priority Data
Mar. 4, 2005 (JP) 2005-061063(PAT.)
Feb. 24, 2006 (JP) 2006-048014(PAT.)

(51) Int. Cl. H04N 1/00

(52) U.S. Cl. 358/400

(57) ABSTRACT

A layout processing method of dynamically changing the layout of a template having data areas in accordance with contents data presented to the data areas makes a choice of a layout adjustment algorithm to be applied to data areas from a retaining unit for retaining a plurality of layout adjustment algorithms to be applied to data areas and adjusts a layout of a data area in accordance with the chosen layout adjustment algorithm at the time of inserting the contents data in the data area. And it lays the contents data out and outputs them in the adjusted data area.

### FIELD OF THE INVENTION

The present invention relates to a technique of generating, editing, and printing a document containing texts and images and, more particularly, to generation, editing, and printing of a variable data document.

### BACKGROUND OF THE INVENTION

Since the merchandise service life decreases recently due to a variety of merchandise items, and the number of consumers with customization service orientation increases along with the penetration of the Internet, the necessity of CRM (Customer Relationship Management) and one-to-one marketing has received a great deal of attention. These methods are very effective for purposes of increasing the customer satisfaction and winning and networking new customers.

The one-to-one marketing is a kind of database marketing. Personal attribute information such as the age, sex, hobby, taste, and purchase log of each customer is stored as a database. The contents of the information are analyzed, and a proposal that meets customer's needs is presented. A typical method of the one-to-one marketing is variable print. Especially, along with the recent progress in DTP (DeskTop Publishing) technology and the spread of digital printers, variable print systems have been developed, which customize and output a document for each customer. Such a variable print system is required to create a customized document in which contents in quantity that changes for each customer are laid out in an optimum manner.

Generally, when such a customized document is to be created by a variable print system, containers are laid out on the document. A container indicates a partial area (data area) to draw a content (drawing content) and is sometimes called a field area. More specifically, containers are laid out on the document, and a database and the layout are associated with each other (each content in the database is associated with each container). With this operation, a customized document (document) is created. In this specification, such a document will be referred to as a variable data document.

In the variable print system, a content which is different for each customer can be inserted in each of the containers laid out. The size of data to be inserted in a content is flexible. If the size of a container is fixed, the following problem arises. For example, when text data having a size larger than the container size is inserted, the text cannot wholly be displayed in the container. Alternatively, when image data having a size larger than the container size is inserted, the image is partially missing. Such a problem is called overflow.

If the content is image data, the image may be reduced and drawn in the container. However, the image may be excessively small. There is also proposed a technique in which if text data whose size is larger than a fixed container size is inserted, the font size of the text is reduced to display the entire text in the container. However, if the font size is adjusted, it may be too small to balance the whole document, or the document may become difficult to read.

The “layout design apparatus” of Japanese Patent Laid-Open No. 7-129658 discloses an automatic layout technique to solve the above-described problems. In this technique, when the size of a character area becomes large, the size of an adjacent area is reduced to maintain the interval between them.

In the technique described in Japanese Patent Laid-Open No. 7-129658, it is written that the character area becomes bigger as the text is inputted. When the size of the character areas becomes large, however, adjacent areas are reduced in size to keep the distance between them. Therefore, the technique has a problem in that as the inputted amount of text increases, adjacent areas are reduced in size.

Further, the technique described in Japanese Patent Laid-Open No. 7-129658 does not take account of a variable print system which creates a customized document for each customer by inserting contents data with the above-described database associated with each layout frame.

As a layout method which takes account of variable data print, a method for creating a fixed container and inserting contents data in the fixed container has been developed. If a container of a fixed size is used and contents data of a size larger than the container size is inserted into the container, however, the method has a problem of overflowing. In such a case, if a user reduces the font size for the contents data and forces to insert the data into the container, the method has a problem in that the font size becomes excessively small. Another method can be considered for changing the container size larger or smaller according to the size of contents data to be inserted. If two containers are associated with each other and the size of one of the containers becomes larger, however, the other container is forced to be smaller according to the size of the container which becomes larger. That disables layout processing considering the size balance between containers.

Therefore, a method of laying out considering the size balance between a plurality of containers associated with each other is required. If the size of each container is changed according to the size of contents data to be inserted into the container, layout processing for adjusting variation of each container size enables the layout processing considering the size balance between containers associated with each other.

One of the objects of the above-described one-to-one marketing is, however, to create a catalog or brochure to meet a customer's needs. In such a case, it can be assumed to create different brochures or catalogs for respective customers.

In order to create such various brochures or catalogs, only the above-described layout adjustment algorithm for adjusting variation of the container size according to the size of contents data is not enough to generate an optimum layout for a user.

With the above-described layout adjustment algorithm, a user cannot set how to change the size of the container when layout calculation is automatically executed according to the data size of the database. Accordingly, the algorithm cannot flexibly reflect the user's intention such as to change a drawing size of the contents in preference to the designed size for a certain container while keeping the designed size for another container as much as possible in a document to be created.

### SUMMARY OF THE INVENTION

The present invention has been made in consideration of the above problems, and has an object to enable an output result desired by a user also in variable print dealing with the above-described various contents data. For example, the present invention implements layout processing for adjusting the contents data in a data area by using an applicable layout adjustment algorithm from a plurality of layout adjustment algorithms.

The present invention has another object to implement layout processing which can flexibly reflect user's intention by enabling any layout adjustment algorithm to be set for each area.

According to one aspect of the present invention, there is provided a layout processing method for changing dynamically a layout of a template including a data area according to contents data to be drawn in the data area, comprising: a selecting step of selecting a layout adjustment algorithm to be applied to the data area from a plurality of layout adjustment algorithms; a layout adjusting step of adjusting a layout of the data area according to the layout adjustment algorithm selected in the selecting step in inserting contents data into the data area; and an outputting step of laying out the contents data and outputting the contents data to the data area adjusted in the layout adjusting step.

According to the present invention, information processing apparatus for executing the above-described layout processing method is provided.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a block diagram showing an arrangement of a variable print system according to an embodiment;

FIG. 1B is a block diagram showing the schematic arrangement of a host computer shown in FIG. 1A;

FIG. 1C is a view for explaining the outline of variable data print;

FIG. 2 is a block diagram showing another arrangement of the variable print system according to the embodiment;

FIG. 3 is a view showing an example of a user interface according to the embodiment, which includes a menu bar, tool bar, work area, and floating palette;

FIG. 4 is a view showing a display example of containers in the user interface;

FIGS. 5A to 5D are views for explaining container rules according to the embodiment;

FIG. 6 is a flowchart for explaining link creation processing according to the embodiment;

FIGS. 7A to 7C are views showing an example of transition of the user interface in creating a link;

FIG. 8 is a flowchart showing layout calculation processing by a layout engine according to the embodiment;

FIG. 9 is a flowchart showing layout calculation processing by the layout engine according to the embodiment;

FIGS. 10A to 10C are views for explaining layout calculation processing according to the embodiment;

FIG. 11 is a view for explaining a set of containers in layout calculation according to the embodiment;

FIG. 12 is a view showing a display example in the user interface when containers are laid out by a flexible link;

FIG. 13 is a flowchart for explaining processing of setting a flexible link by the user interface according to the embodiment;

FIG. 14 is a view showing a link setting dialogue window according to the embodiment;

FIG. 15 is a view showing an example of a layout result by a fixed link;

FIG. 16 is a view showing an example of a layout result by a flexible link;

FIG. 17 is a flowchart showing an overall flow of automatic layout processing according to this embodiment;

FIG. 18 is a flowchart for explaining layout optimizing processing according to this embodiment;

FIG. 19 is a flowchart showing parsing of an applied algorithm which is executed in step S1802 for a container selected in step S1801;

FIG. 20 is a flowchart showing layout recalculation according to this embodiment;

FIGS. 21A to 21C are diagrams for explaining layout adjustment algorithm of contents priority;

FIGS. 22A to 22C are diagrams for explaining layout adjustment algorithm of container-contents priority;

FIGS. 23A to 23C are diagrams for explaining layout adjustment algorithm of basic design priority;

FIGS. 24A to 24C are diagrams for explaining layout calculation processing when a layout adjustment algorithm of basic design priority and a layout adjustment algorithm of contents priority are set in different containers in a link set;

FIGS. 25A to 25G are diagrams showing examples of a user interface (UI) for setting respective layout adjustment algorithms;

FIG. 26 is a diagram for explaining how each container is set by a layout adjustment algorithm set by each unit;

FIG. 27 is a diagram showing another example of a user interface for setting a layout adjustment algorithm;

FIG. 28 is a flowchart showing processing for displaying the UI of FIG. 27;

FIGS. 29A to 29D are diagrams showing examples of layout calculation when a layout adjustment algorithm of container-contents priority and a layout adjustment algorithm of contents priority are set in different containers in a link set;

FIG. 30 is a diagram showing an example of storing of algorithm information;

FIG. 31 is a diagram for explaining layout optimization processing;

FIG. 32 is a drawing describing an algorithm of a contents-prioritized layout;

FIG. 33 is a drawing exemplifying Layouts for describing a layout calculation method and a result in the case where the least-squares method has been used as well as a layout calculation method and a result in the case where the least-squares method is not used;

FIG. 34 is a drawing describing a container contents-prioritized layout algorithm; and

FIG. 35 is a block diagram showing a functional configuration of a layout editing application program 121 according to the present embodiment.

### DETAILED DESCRIPTION OF THE PREFERRED EMBODIMENT

Preferred embodiments of the present invention will now be described in detail in accordance with the accompanying drawings.

<System Arrangement>

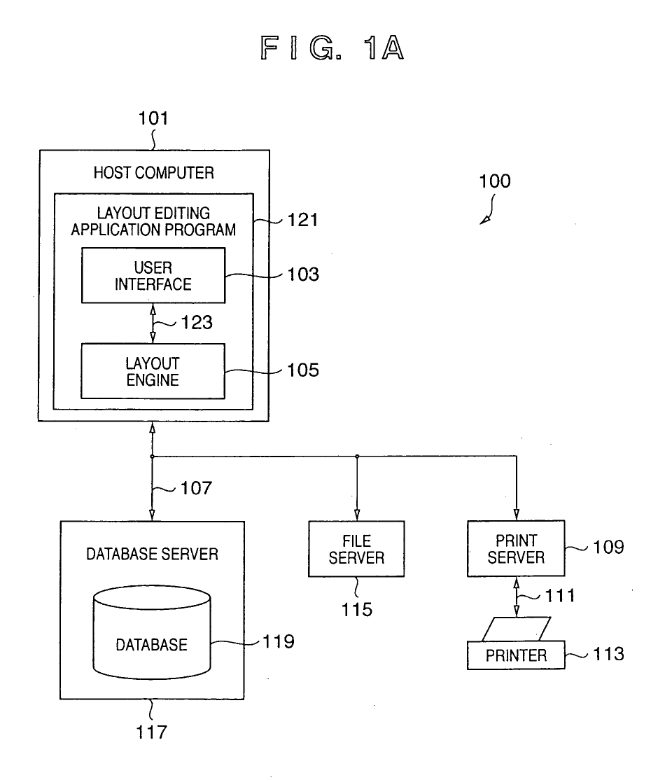

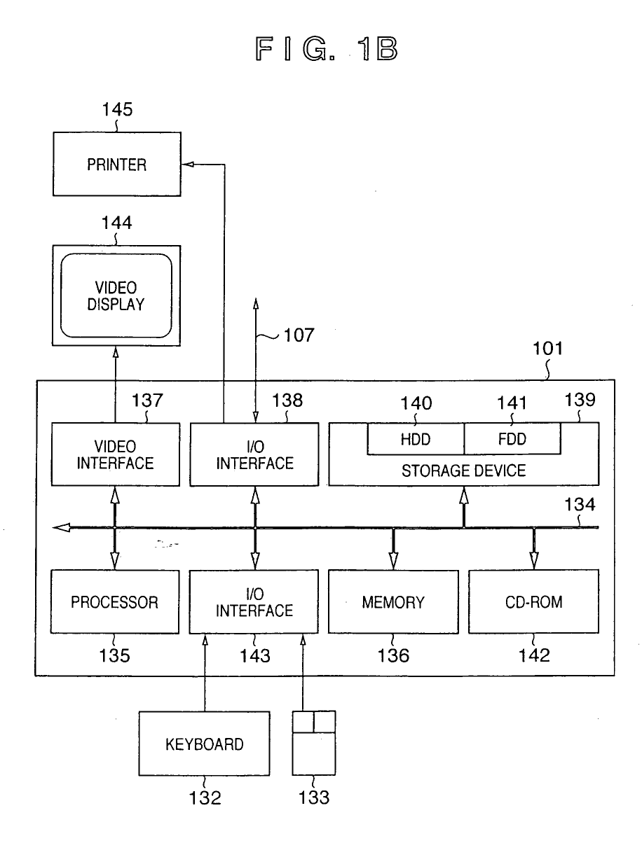

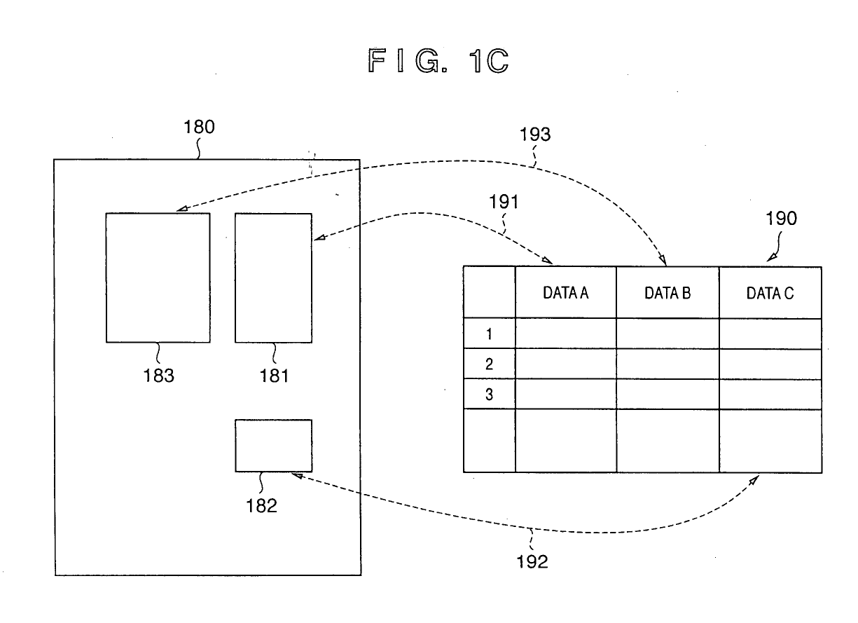

The arrangement of a variable print system according to the embodiment will be described first with reference to FIGS. 1A and 1B. FIG. 1A is a block diagram showing an arrangement of a variable print system 100 to print a variable data document. FIG. 1B is a block diagram showing the arrangement of a host computer 101 shown in FIG. 1A in more detail. Variable print processing to be described in this embodiment is executed by the host computer 101 (including general-purpose computer modules) serving as a layout adjustment apparatus. The software of a layout editing application program 121 (layout adjustment program according to the present invention) executable on the system 100 is wholly or partially executed by the host computer 101. Especially, processing for layout editing or processing for printing a variable data document is implemented by the software executed by the host computer 101.

The layout editing application program 121 is stored in a computer-readable medium. The layout editing application program 121 is loaded from the computer-readable medium to a memory 136 of the host computer 101 and executed. The computer-readable medium which stores such software or computer program is a computer program product. When the computer program product is used by a computer, an apparatus suitable for layout editing or variable print of a document is provided.

As shown in FIG. 1B, pointing devices such as a keyboard 132 and a mouse 133 serving as input devices are connected to the host computer 101 through an input/output interface 143. A display device 144 serving as an output device is connected through a video interface 137. A local printer 145 or the like may be connected through an input/output interface 138. The input/output interface 138 also has a function of connecting the host computer 101 to a network 107. With this arrangement, the host computer 101 can be connected to another computer apparatus in the system 100 through the network. Typical examples of the network 107 are a local area network (LAN) and wide area network (WAN).

As shown in FIG. 1B, the host computer 101 includes at least one processor unit 135 and the memory unit 136 including, e.g., a semiconductor random access memory (RAM) or read-only memory (ROM). A storage device 139 includes a hard disk drive 140 and floppy (registered trademark) disk drive 141 capable of transmitting/receiving data to/from the computer-readably medium which stores the program. Although not illustrated in FIG. 1B, a magnetic tape drive can also be used as the storage device 139. A CD-ROM drive 142 is provided as a nonvolatile data source (the computer program may be provided by a CD-ROM, as a matter of course).

The host computer 101 uses the components 135 to 143 of the computer module 101, which communicate through an interconnection bus 134, typically in a form according to an operating system such as GNU/LINUX or Microsoft Windows (registered trademark) or by a method by the conventional operation mode of a computer system formed by a known associated technique. That is, the above-described components 135 to 143 are communicably connected through the bus 134 and used by the operating system installed in the host computer 101.

Examples of the host computer 101 shown in FIG. 1B are an IBM-compatible PC or Sparcstation available from SUN, or a computer system including them.

<Outline of Layout Editing Application>

In this embodiment, the layout editing application program 121 is resident in the hard disk drive 140, and its execution or reading is controlled by the processor 135. Data of the layout editing application program 121 that are fetched from the intermediate storage device and the network 107 use the semiconductor memory 136 in response to the hard disk drive 140.

As an example, the encoded program of the layout editing application 121 is stored in a CD-ROM or floppy (registered trademark) disk, loaded through the corresponding drive 142 to 141, and installed in the hard disk drive 140. As another example, the layout editing application program 121 may be loaded from the network 107 into the host computer 101 and installed in the hard disk drive 140. The software may be loaded in the host computer 101 by using a magnetic tape, ROM, integrated circuit, magnetooptical disk, wireless communication using infrared rays between the host computer 101 and another device, a computer-readable card such as a PCMCIA card, or another appropriate computer including e-mail communication, an intranet, or the Internet having recording information on a WEB site. These are examples of computer-readable media. Any other computer-readable medium may be used.

Referring to FIG. 1A, the layout editing application 121 of the present invention causes the computer to execute variable print (also called variable data print (VDP)). The layout editing application 121 includes two software components, i.e., a layout engine 105 and user interface 103. The layout engine 105 is a software component which loads each record of variable data stored in a database 119 in accordance with the constraints of the sizes and positions given to containers (rectangular ranges) as partial areas and calculates, on the basis of the read data and the constraints of the containers, the size and position of each container in which the readout data should be inserted. In this embodiment, the layout engine 105 also executes processing of drawing data assigned to a container to generate an image of a variable data document. However, the present invention is not limited to this. For example, the layout engine 105 may run as an application to determine the size and position of each partial area (container) and output drawing information to a printer driver (not shown). In this case, the printer driver may execute image drawing processing of a variable data document and generate print data. The user interface 103 allows a user to set the layout and attribute of each container and causes him/her to create a document template. In addition, the user interface 103 provides a mechanism to associate each container in the document template with a data source. The user interface 103 and layout engine 105 communicate with each other through a communication channel 123.

FIG. 1C is a view for explaining the outline of variable data print according to this embodiment. A plurality of containers 181 to 183 are laid out on a page in accordance with an operation instruction from the user through the user interface module 103 (to be referred to as the user interface 103 hereinafter) of the layout editing application 121. Then, constraints about the position and size are given to each container, thereby generating a document template 180. The user interface 103 also associates the document template 180 with a data source 190 (database 119 in FIG. 1A) and each container with a data field in the data source 190. The association information representing the association between each container and a data field in the data source 190 is described in the document template. The document template is stored in the HDD 140 or memory 136. The data source 190 is a file in which item data (variable data) is described for each record. The data source 190 is stored in the HDD 140. In accordance with a print instruction or preview instruction from the user, the layout engine 105 reads out the variable data associated by the association information from the data source 190, inserts the data in the containers 181 to 183 of the document template for each record (for example, data fields A to C of data record 1 are inserted in the containers 181 to 183), and adjusts the size of each container in accordance with the inserted data (layout adjustment). A way of adjusting layout is described below. When a preview instruction is input, a layout-adjusted document image is generated and output so that the image is displayed on the screen of the video display 144 as a preview. When a print instruction is input, a document image generated by using the layout engine 105 or printer driver is output to the print server 109 as print data. Variable data print is implemented by sequentially processing data records 1, 2, 3, . . . .

The data source (190) for document generation may be, e.g., the general database 119 on a database server 117 formed by another computer which is making the database application run. In this case, the host computer 101 can acquire the data source by communicating with the database server 117 through the network 107. The document template (180) for variable data print, which is generated by the layout editing application 121, is stored in the host computer 101 or a file server 115 formed by another computer. As described above with reference to FIG. 1C, the layout engine 105 of the layout editing application 121 generates a variable data document containing a document template merged with data. The document is stored in the local file system of the host computer 101 or in the file server 115, or transmitted to and printed by a printer 113. The print server 109 is a computer to provide a network function to a printer which is not connected directly to the network. The print server 109 and printer 113 are connected through a general communication channel 111.

<Another System Arrangement>

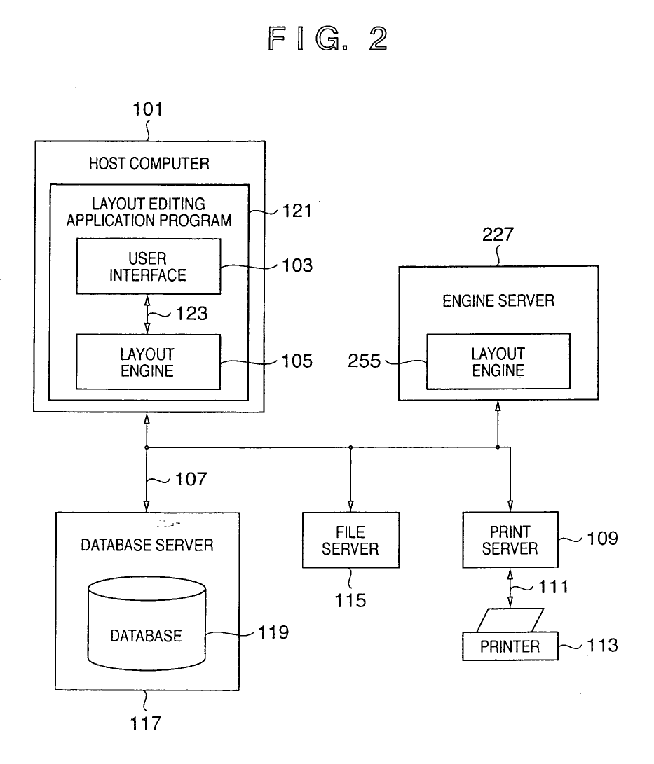

FIG. 2 is a block diagram similar to FIG. 1A. An engine server 227 is added. A layout engine 225 stored in the engine server 227 is a separate version of the layout engine 105. As the engine server 227, a general computer is used. The layout engine 225 combines a document template stored in the file server 115 with data stored in the database 119 to generate a variable data document for printing or another purpose. This operation is requested through the user interface 103.

<Description of Layout Editing Application>

The layout editing application 121 will be described below.

[Main Window]

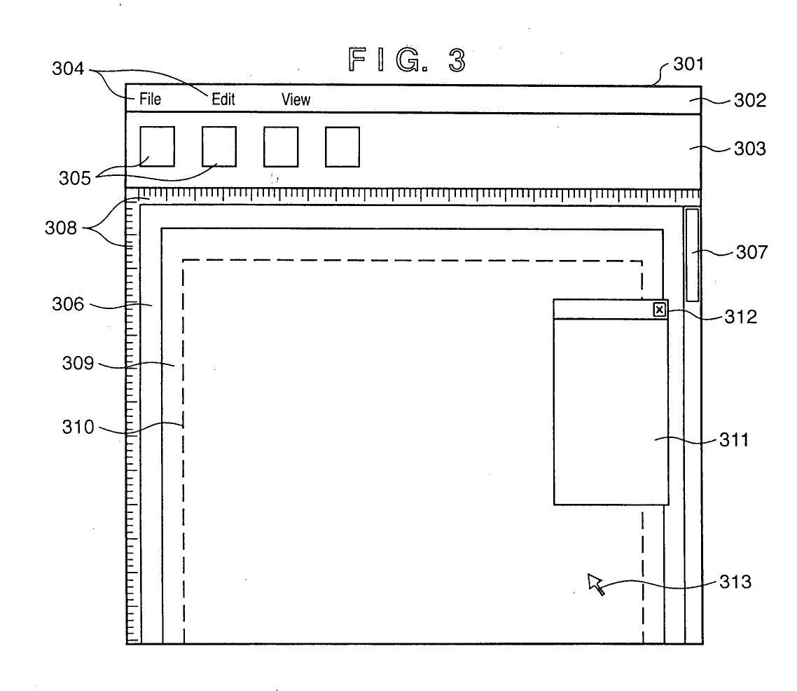

At the time of operation, the user interface 103 causes the video display 144 to display a user interface window formed by an application window 301 shown in FIG. 3. The window 301 has a menu bar 302, tool bar 303, work area 306, and optional palette 311. The menu bar 302 and tool bar 303 can be set in a non-display state or moved to various positions on the screen. The position of the work area 306 can be moved by operating the mouse 133. The palette 311 is an option. A cursor/pointer device 313 represents a position indicated by the mouse 133.

The menu bar 302 as a known technique has a number of menu items 304 extended under the layer of menu options.

The tool bar 303 has a number of tool buttons and widgets 305 which can be set in a non-display state or display state by a special mode of the application.

A ruler 308 is an option and is used to indicate the position of a pointer, page, line, margin guide, container, or object in the work area.

The palette 311 is used to access an additional function such as a variable data library. The palette 311 has a window control 312 to move, resize, or close it. The palette 311 can optionally be displayed on the foreground of the work area or hidden behind an object. The palette 311 can be displayed only within the application window 301 or can partially or wholly be displayed outside the application window 301.

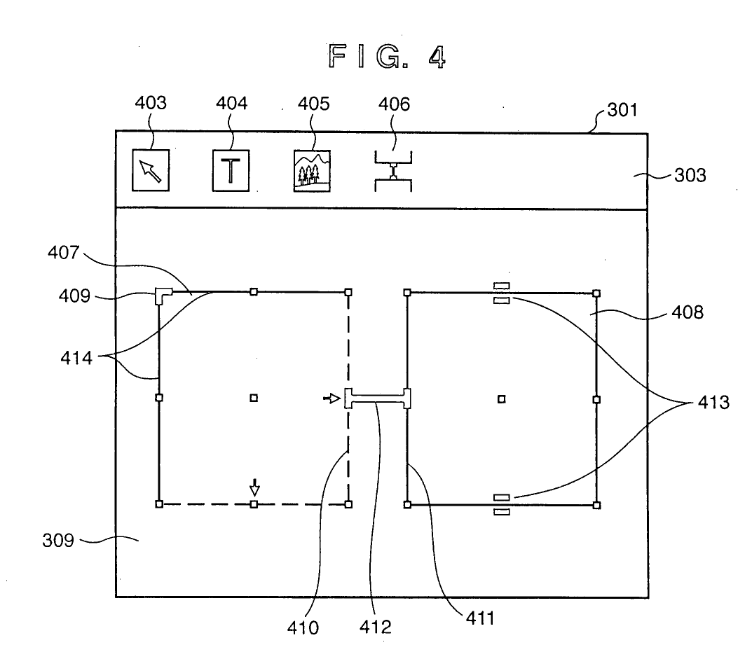

User-selectable “buttons” as shown in FIG. 4 are laid out on the tool bar 303.

(1) Select tool button 403: This button is used for edge selection, movement, size change, resize, or lock/unlock of a container. A container is selected by dragging a select box around the container. When a plurality of containers are selected while keeping the CTRL key pressed, the plurality of containers can be selected.

(2) Text container tool button 404: This button is used to create a container having a static or variable text.

(3) Image container tool button 405: This button is used to create a container having a static or variable image.

(4) Link tool button 406: This button is used to create a link to associate containers with each other. This button is also used to control the distance of the link.

In the application window 301 of the layout editing application 121 shown in FIG. 3, when containers and links are laid out in a page, a basic layout can be determined. The basic layout is a layout as a base of variable data print. When containers in the basic layout are fixed containers, all record print results have the same layout. When at least one of the containers in the basic layout are flexible containers, the size or position of each container varies within the constraint range (to be described later) in accordance with the amount or size of data inserted for each record. The document template created by the layout editing application 121 is strictly used to determine the basic layout. When a flexible container is included, the final layout of a printed product is adjusted in accordance with read data.

[Document Template]

Referring to FIG. 3, the work area 306 is used to display and edit the design of the document template (180: basic layout). The document template may simply be referred to a template. The outline of a document to be printed can be presented to the user in the process of causing him/her to design the document template. Accordingly, the user can easily understand how the document merged with the data source (190) changes on the basis of the amount and size of variable data.

When the data source is associated with the document template, a corresponding variable text or image is displayed in each container laid out so that a preview of the current document can be obtained.

In the document template creation mode, visual keys (e.g., frame lines of containers, anchors, sliders, and links) which express the document structure and variable data containers in the document template are always displayed. In the preview mode in which variable data are inserted, the visual keys are displayed when the cursor is moved onto a container, or a container is selected.

The work area 306 includes a scroll bar 307, the optional ruler 308, and a document template 309. The document template 309 can indicate the presence of a plurality of pages. The document template 309 indicates the document template 180 shown in FIG. 1C.

The page size of a given document template is designated by the user by using a known technique. For example, “Page Setup” is selected from “File” of the menu to display a dialogue to set the page size, on which the page size designated by the user is reflected. The actual number of pages of each document can change depending on the variable data in the associated data source. This is because when a field like a flexible table whose size is changed in accordance with the amount of variable data is set in the document template, and variable data which cannot be fitted in one page is read, an additional page is automatically created.

A border 310 shown in each page is an arbitrary page margin representing the maximum width of an object printable on the page.

FIG. 4 is a view showing examples of objects which can be displayed on the document template 309 of one page. The objects include containers 407 and 408, an arbitrarily applied anchor icon 409, fixed edges 411 and 414, an unfixed edge 410, a link 412, and sliders 413. The term “object” described in the present application defines all that can be displayed on a document template. The objects are differentiated by their name in description. The anchor icon 409 can be set at a corner or edge of the rectangle of a container or the center of a container. When the anchor icon 409 is set, the position of the set point is fixed. That is, in the example shown in FIG. 4, the anchor icon 409 is set at the upper left corner of the container 407. When variable data is inserted in the container 407, and the image size or text amount of the variable data is large, the container can be enlarged to the right and lower edges. When the anchor icon 409 is set on any one edge, for example, the edge is fixed. The container can be enlarged in the directions of the three remaining edges. When the anchor icon 409 is set at the center of a container, the central position of the container is fixed. The container can be enlarged in four directions without changing the central position of the rectangle of the container. The link 412 (to be described later in detail) indicates that the containers 407 and 408 are associated with each other. It is indicated that the container 408 can be moved to the right while maintaining the length (the range can be designated) set for the link 412 (for a flexible sized links to be described later, the length of the link depends on data size to be inserted within set range). The sliders 413 indicate that the container can be moved in parallel to the edges on which the sliders are set.

[Container]

A container will be described. A container is a space (called a partial area or data area) where a fixed or flexible text or image is inserted from a variable data file to the document template and drawn. A container is laid out together with other containers and objects, as shown in FIG. 4. Movement, size adjustment, and re-creation of the container are done by operating the mouse 133 on the basis of an operation instruction from the user through the user interface window. Data inserted in the container is called a content or contents data (variable data or field data).

More exactly, the container has a set of settings, visual expression, interaction, and editing operation. The definition of a container according to this embodiment will be described below.

(1) A container has a fixed or flexible content. A flexible content can be regarded as dynamic because data acquired from the data source can change for each document, i.e., each record. In this embodiment, however, animated contents and contents which change over time by another method are not assumed as a flexible content because they are not suitable for printing. A fixed content is displayed in a similar manner in all documents generated by using containers. However, when a fixed content and a flexible content is associated by a link, the fixed content may be affected by the flexible content and change its position in each document.

(2) A container has ornament functions like text settings such as a background color, border, and font style applied to a content. This setting is called a container attribute. The container attribute can be set for each container. The setting can also be done such that a container has the same container attribute as another container.

(3) A container is merged with data from the data source in generating a document. The ornament function can visually be recognized on a printed output product for all fixed contents. A flexible content provides display of specific data from the data source. This expression of the container can be, e.g., printed or displayed on the screen of the video display 144, or subjected to both printing and display.

(4) A container has a user interface as a visual key, as shown in FIG. 4. A container has, e.g., an interactive graphical user interface (GUI) to edit the container or set display. Each element of the GUI is displayed on the screen of the video display 144 but not printed in the document. The user interface 103 of the layout editing application 121 has a function of displaying some of the ornament functions of a container such as the background color and font and allowing editing and display of settings of the container.

[Constraints of Container]

Each container has constraints about control for the manner contents displayed by the respective documents are combined. These constraints (including combining a fixed or flexible content with a container) are used as a principal method of causing the user to control the generations of a number of documents from one document template. An example of the constraint is “the maximum height of the content of this container is 4 inches”. Another example of the constraint is “the left edge (left side) of the content of the container must be displayed at the same horizontal position in each document”. The contents described here indicate various methods of displaying and editing such constraints by using the GUI.

A contents place holder which designates the layout of a fixed content like an image having a defined place on a page is well-known in the digital print technique. Each container has a position and size. The containers are edited and displayed by a method as a known technique. The following description will be made with a focus on display and editing in a method specialized to variable data print.

When containers are used, the user can designate the sizes (drawing sizes) and positions of contents in a document. Since many kinds of documents are generated from one document template, a number of possibilities and constraints are set for the containers. To set (designate) and display them, a predetermined user interface is used.

The edges of one container define the virtual border of an associated content displayed in the document. Hence, discussion about the left edge of a container is equivalent to discussion about the leftmost edge of an area where an associated content can be displayed in each document. Similarly, discussion about the height of a container can be understood as discussion about the constraint of the height of an associated content in the generated document. In this specification, they are clearly distinguished in discussing the edge or size of a container by referring to the user interface 103.

In the following description, the term “fixed”, which defines a certain value used to restrict display of a content, applies to all documents in the same way.

(1) When the width of a container is fixed, the width to be assigned to an associated content is the same in all documents.

(2) When the height of a container is fixed, the height to be assigned to an associated content is the same in all documents.

(3) When a distance (link length) is fixed, the designated distance is a constraint in all documents.

(4) When the left and right edges of a container are fixed, the horizontal positions of edges related to the page are the same in all documents. However, the height or vertical position of the container can change. For example, when the left edge of a container is fixed, the left edge of an associated content is displayed at the same horizontal position in all documents. However, the content may be displayed on the upper edge of the page in a document and on the lower edge of the page in another document.

(5) When the upper and lower edges of a container are fixed, the vertical positions of edges in the page are the same in all documents. However, the width or horizontal position of the container can change for each document.

(6) The vertical axis of a container is a virtual vertical line which is parallel to the right and left edges of the container and is located at the intermediate position therebetween. When the vertical axis of the container is fixed, the central positions of the horizontal positions of the left and right edges of the container (i.e., the central position between the left and right edges) is the same in all documents. In this constraint, the width of the container can change. However, the vertical axis is located at the same horizontal position in all of documents independently of whether the left and right edges are nearest to or farthest from the vertical axis. Note that the height and vertical position of the container are not affected by this constraint.

(7) Similarly, when the horizontal axis is fixed, the average of the upper and lower edges of a container is located at the same vertical position. However, the width and horizontal position of the container are not affected by this constraint.

(8) When both the horizontal axis and the vertical axis are fixed, the central position of the container is fixed. However, the width and height of the container are not affected by this constraint.

(9) When the angular position of a container, the intermediate position of an edge of a container, or the central position of a container is fixed, the position is the same in all documents. For example, when the upper left corner of a container is fixed, the upper left position of the container laid out is the same in all documents.

(10) The vertical edges or vertical axis can be fixed in association with the left or right edge of the page, left or right page margin, or another horizontal position. Similarly, the horizontal edges or horizontal axis can be fixed in association with the upper or lower edge of the page, upper or lower page margin, or another vertical position.

A term opposite to “fixed” is “flexible” which indicates that an edge, axis, corner, or intermediate position of a container or a document constraint can change between documents (between records). For example, in a page, the layout is expected to dynamically change depending on the size or amount of variable data. However, the user may want that the size or position of a specific container is fixed, or the four corners of a container at a corner of the page is fixed. For this purpose, the layout editing application 121 can appropriately set, for each container (partial area), whether to fix or change an edge, axis, corner, or intermediate position. Hence, the user can create a desired basic layout in determining the basic layout of the document template 180.

[Display/Editing of Container]

-Method of Creating New Container-

Containers are described in two types, i.e., text container and image container. A text container has a text and an embedded image. An image container has only an image.

As shown in FIG. 4, a new text container or image container is created on the document template 309 by clicking the mouse 133 on the text container tool 404 or image container tool 405 and dragging a rectangle on the document template 309.

Alternatively, a container may be created by activating the appropriate tool 404 or 405 and simply clicking the mouse on the document template 309. In this case, a container having a default size is inserted on the template in accordance with the click operation of the mouse 133. In addition, a dialogue box or prompt to set the size of the new container is provided. The container size can be set by various methods. For example, the size may be defined automatically in advance, or a container may be created and laid out by a calculated schema. When the generated container is selected by an input means such as the mouse, and its properties are displayed by clicking on the right button of the mouse, the container property dialogue is displayed so that constraints for the container can be set. In the container property dialogue UI (corresponding to a partial area setting means), various kinds of constraints described above can be set. In the container property dialogue, the size (width and height) and position of the container can be set. When the container is set a flexible size, the basic pattern (basic size and reference position) of the container is set. In addition, the maximum container size (width and height) and the minimum container size (width and height) can be set.

[Container Display Method]

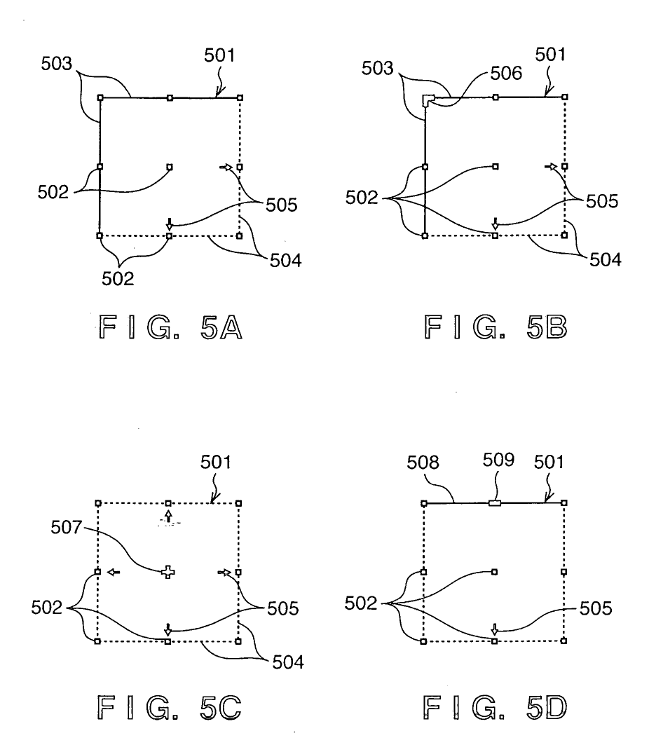

FIGS. 5A to 5D show display rules about the edges of a container.

To express the state of an edge of a container, the application 121 expresses an edge by using a solid line (item 503) or a dotted line (504). In addition, the application 121 uses anchors (line, shape, and icon indicated by 506, 507, and 509 drawn near the edges), handles (control points 502 drawn on or near the edges of the area for movement and correction), sliders (short parallel lines drawn on both edges of an edge, 403 in FIG. 4), enlarge/reduce icons (505), and colors.

The rules of the container display method shown in FIGS. 5A to 5D are as follows.

(1) To fix an edge, it is drawn by a solid line.

(2) When the width is fixed, the left and right edges are drawn by solid lines.

(3) When the height is fixed, the upper and lower edges are drawn by solid lines.

(4) The axes are not drawn.

(5) Enlarge/reduce icons are drawn near each of edges which are not drawn according to the rules (1) to (3). The edges are drawn by dotted lines.

(6) When the pair of vertical and horizontal edges or the pair of vertical axis and horizontal axis are fixed, an anchor is drawn at the intersection between them.

(7) When no anchor is drawn anywhere on a fixed edge, a slider is drawn at the center of the edge.

(8) When neither anchor nor slider is drawn for the pair of vertical and horizontal edges or the pair of vertical axis and horizontal axis, a handle is drawn at the intersection between them.

The lines defined by the rules (1), (2), and (3) are fixed or restricted, as described above, and drawn by solid lines. Flexible edges defined by the rule (5) are drawn by dotted lines. Fixed points defined by the rules (6), (7), and (8) represent anchors. Some fixed edges represent sliders. Remaining points represent handles.

In the above-described rules, higher priority is given to a constraint set by the user later. That is, when another constraint is set later, and it can affect edges which should be drawn in accordance with the above-described rules, the drawing contents of solid line or dotted lines are changed.

The location where a flexible edge is drawn depends on the content of the container. As will be described later, “dynamic calibration processing” is used, which indicates that a content is merged with a document template and made visible by the user interface. The location where a flexible edge is drawn in the user interface can be determined with another means. For example, the location where a flexible edge is drawn can be determined with a container of a size averaged in all the documents (averaged contents area).

These content expressions provide a graphical means for displaying the state of each edge of a container. The expressions can be interpreted in the following way.

(1) A dotted line indicates that the position of the edge in the document changes depending on the content of the container, like the edge 410 shown in FIG. 4.

(2) A solid line indicates that the edge is restricted because it is fixed (edge 414), or the width or height of the container is fixed (in the container 408, the four edges are indicated by solid lines so that both the width and height are fixed).

(3) An anchor indicates that the point where edges or axes cross is fixed. Hence, the anchor point appears at the horizontal and vertical positions in all documents. The anchor is fixed, as a matter of course. The icon 409 in FIG. 4 is an example of an anchor icon which indicates that the position at which the edges 414 cross is fixed.

(4) A slider indicates that the associated edge can be translated although it has a fixed length. For example, the sliders 413 in FIG. 4 indicate the content data inserted in the container 408 may be displayed on the left or right edge of a position represented by a specific diagram in the document. For example, when the image size or text amount of data inserted in the container 407 associated with the container 408 (a link is set between the containers) is small, the size of the container 407 becomes small. For this reason, the container 408 is slid (translated) to the left and laid out. When the size of the container 407 becomes large, the container 408 is slid conversely to the right and laid out.

Some or all of these icons and edges are drawn or not drawn depending on which tool or which container is selected/highlighted or activated. Generally, the container edges and icons are not drawn on a printed product because they are assistant tools for designing the document template.

As described above, settings for the basic pattern including the basic values, minimum values, and maximum values of the width and height of a container are displayed in a secondary dialogue window.

Referring to FIG. 5A, in a container 501, neither the width nor height is fixed (flexible). The fixed edges 503 are expressed by solid lines. The flexible edges 504 are expressed by dotted lines. The enlarge/reduce icons 505 represent the adjacent edges 504 are flexible. An indicator in another form may be used instead or additionally.

Referring to FIG. 5B, in the container 501, both the width and height are flexible. The anchor icon 506 is added to explicitly represent that the position of the corner at which the edges 503 cross is fixed.

Referring to FIG. 5C, in the container 501, both the width and height are flexible. In this state, the container can extend equally from the central point indicated by the arbitrary anchor icon 507. That is, the container 501 can be enlarged or reduced about the anchor icon 507. In enlargement/reduction, the layout is adjusted such that the anchor icon 507 is always located at the central point of the container 501.

Referring to FIG. 5D, although an upper edge 508 of the container 501 is fixed, both the width and height are flexible. The anchor icon 509 located at the center of the upper edge 508 is fixed. The left and right edges (502) of the container 501 enlarge or reduce the container about the central axis (vertical axis) extending perpendicularly through the anchor icon 509.

[Link]

A link indicates the association between a container and another container. The association indicates the distance between the containers. The layout of containers associated by a link is calculated in consideration of the influence of their layout change. Reference numeral 412 in FIG. 4 denotes a link which associates the containers 407 and 408 in FIG. 4. The link setting method and the layout calculation method of containers associated by a link will be described later.

[Link Setting Method]

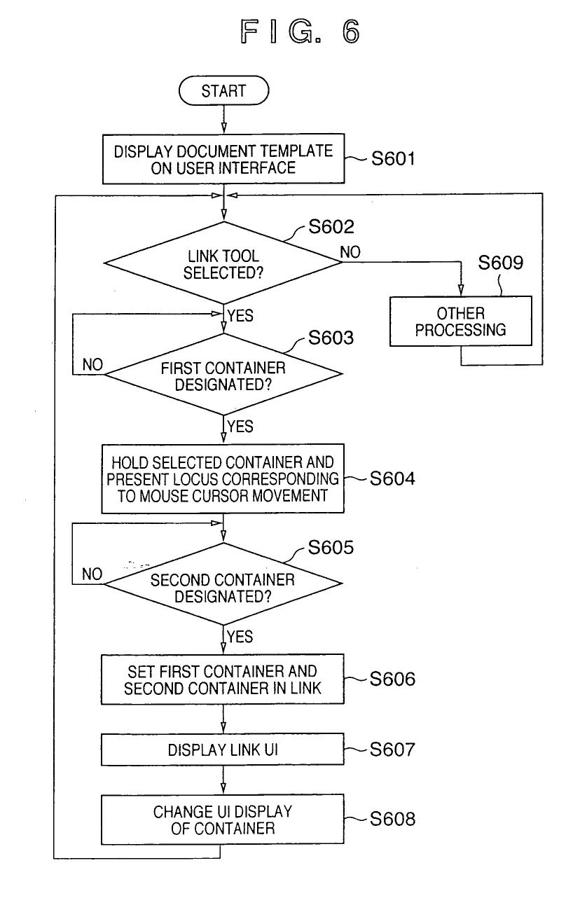

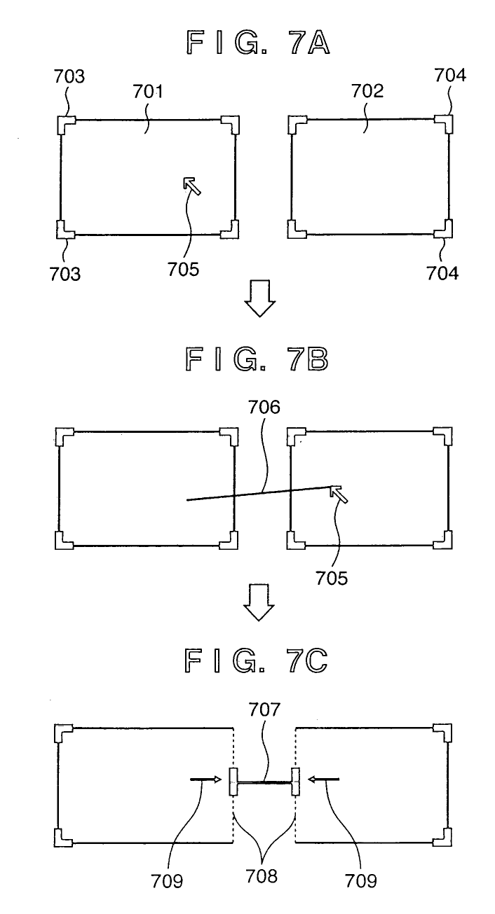

Setting of a link to associate containers with each other will be described next. FIG. 6 is a flowchart showing the link setting method. FIGS. 7A to 7C show an example of transition of the user interface (UI) in setting a link. A method of setting a link between containers will be described with reference to FIGS. 6 and 7A to 7C. Processing in each step of a flowchart described in the present application is executed by the processor 135 in the information processing apparatus (host computer).

First, in step S601, the layout editing application 121 displays a document template selected for editing on the work area 306 of the user interface window. To set a link, containers (at least two containers) to set a link must be created on the document template. FIGS. 7A to 7C show an example of transition of the user interface when two containers are created in step S601, and a link is set.

In step S602, the layout editing application 121 determines whether the above-described link tool is set in a selected state (a selected state is set by clicking on the button 406 shown in FIG. 4). If NO in step S602, another processing is executed as needed (step S609), and the flow returns to step S602.

Referring to FIG. 7A, containers 701 and 702 have only fixed edges. Reference numerals 703 and 704 denote anchors, like the anchor 409 in FIG. 4; and 705, a mouse pointer. When the link tool is in the selected state, the user clicks on one (container 701) of the two containers, for which a link is to be set, to select the container. In accordance with this operation, the user interface 103 of the layout editing application 121 recognizes that the first container is designated (step S603) and holds information to specify the selected container in the memory 136. In addition, a locus corresponding to further movement of the mouse cursor is displayed on the screen (step S604). For example, a line segment 706 shown in FIG. 7B indicates a line which connects the click point in the state shown in FIG. 7A and the current position of the mouse cursor. With this UI, the position where a link is to be set can explicitly be presented to the user.

Next, as shown in FIG. 7B, the user moves the mouse pointer to the other container (container 702) and clicks on it. In accordance with this operation, the user interface 103 recognizes that the second container is designated (step S605). The layout editing application 121 sets a link between the first container held in step S604 and the second container recognized in step S605 as a designated container (step S606).

When the link is set between the two containers 701 and 702 selected by the user, a link UI 707 is displayed (step S607). In addition, when the link is set, the display state of the containers changes to that shown in FIG. 7C (step S608). That is, when the link is set, the UI of the containers is automatically changed. In this case, the edges associated with each other by the link change to flexible edges and are indicated by dotted lines. Referring to FIG. 7C, edges 708 are indicated by dotted lines. That is, the edges 708 are flexible edges, as described above.

The state of the edges of the containers is automatically changed, as shown in FIG. 7C, because the containers must have flexible edges due to link setting. This aims at preventing any contradiction which may occur when all edges are fixed even after link setting. Marks 709 visually show the user the directions in which the containers can change due to link setting, like the icons 505 shown in FIGS. 5A to 5D. In the example shown in FIG. 7C, the right edge of the left container and the left edge of the right container change to flexible edges. This is merely an example. For example, the right container may change to setting with the sliders 413 in FIG. 4.

<Layout Calculation Processing by Layout Engine>

[Layout Calculation Method (Overall Flow)]

The layout editing application program of this embodiment is divided into a layout mode and a preview mode. The layout mode is a mode for creating containers by using the user interface 103 and creating a layout by associating the containers with each other (link setting). The preview mode is a mode where the layout engine 105 inserts each record of a data source in the created layout and previews the layout result after actual record insertion. In the preview mode, contents data in actual records are inserted, and a layout is calculated. In the preview mode, however, the layout for display is calculated. Even in actual printing, the layout is calculated by causing the layout engine 105 to insert data in each container. The calculation method at this time is the same as in the preview mode. If priority order for contents data to be inserted into a container is set, the layout can be calculated according to the priority order. As an example of calculating a layout according to the priority order, it can be assumed to display contents data to be inserted into a container of higher priority order as much the same as the original size (original data size).

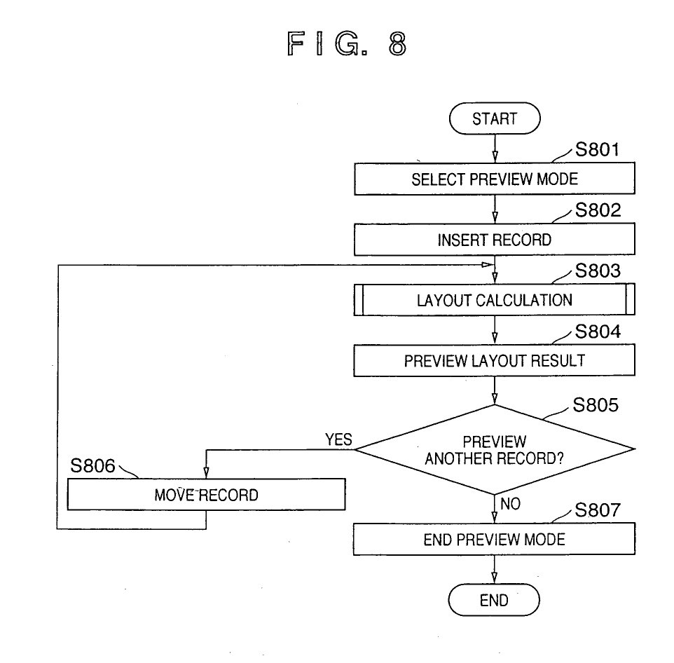

FIG. 8 shows the flow of layout calculation. First, the preview mode is selected (step S801). In the preview mode, the layout editing application 121 causes the user to select a record to be previewed from the data source and determines to insert each field data of the selected record in each container (step S802). When insertion of the field data in each container is determined, the layout editing application 121 executes calculation to lay out the record and executes layout adjustment as needed (step S803). The layout calculation in step S803 will be described later in detail. The layout editing application 121 displays the layout calculated in step S803 (step S804). The layout editing application 121 determines in accordance with a user instruction whether to preview another record (step S805). If NO in step S805, the preview mode is ended (step S807). If YES in step S805, the layout editing application 121 selects another record, executes layout calculation again, and previews the layout (step S806).

When not the preview mode but the print mode is set, layout calculation is done sequentially for all records to be printed. Hence, step S804 is omitted. In step S805, it is determined whether all records to be printed are processed. The layout calculation result in step S803 is output, and print data is generated by using the printer driver and output to the printer. In this case, when print data output is ended for all records (all records designated for printing), the processing is ended.

[Layout Calculation Method (Details)]

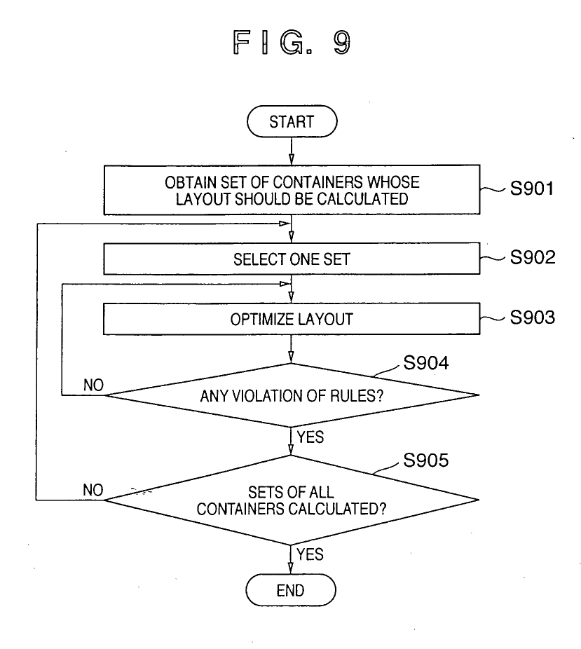

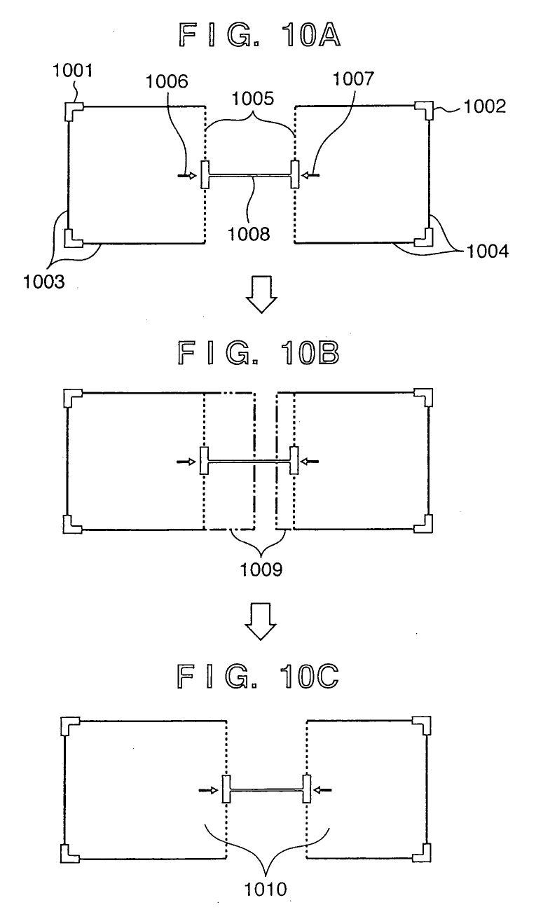

The layout calculation in step S803 will be described next in detail. FIG. 9 is a flowchart showing a layout calculation method when the layout priority order of this embodiment is not set. FIGS. 10A to 10C are views showing an example of the UI display at this time. FIG. 9 is a flowchart for explaining only the layout calculation processing method. This corresponds to the layout calculation method in printing/previewing one record of variable data print. When a plurality of records are present, the following processing is repeated.

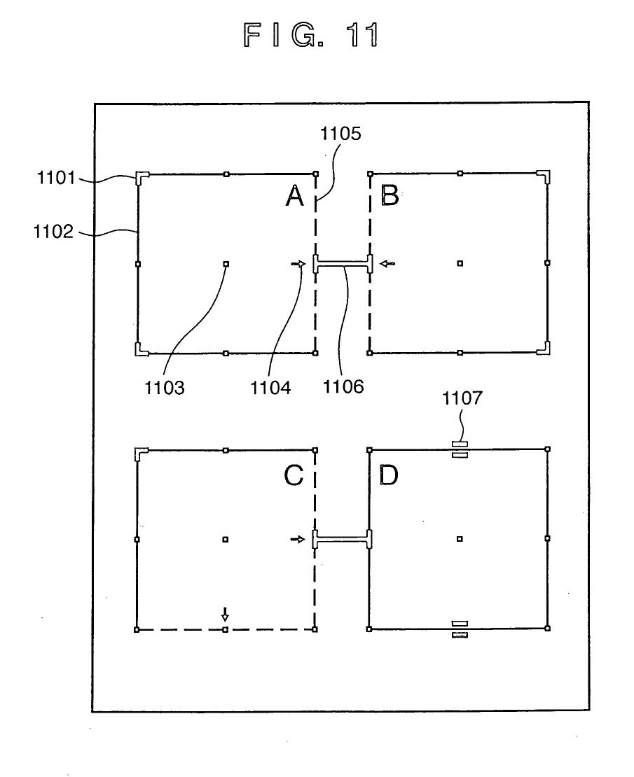

First, the layout editing application 121 obtains a set of containers whose layout should be calculated (step S901). Layout calculation is executed for a set of associated containers. Referring to, e.g., FIG. 11, four containers are laid out on a page and associated with each other. In this case, containers A and B are associated by a link, and containers C and D are also associated by a link. Hence, the containers A and B form set 1, and containers C and D form set 2. That is, a group of containers connected by a link is specified as a set. As described above, reference numeral 1101 denotes an anchor; 1102, a fixed edge; 1103, a controller; 1104, an arrow which indicates the change direction of a flexible edge; 1105, a flexible edge; 1106, a link; and 1107, a slider.

The layout editing application 121 selects a set as a layout calculation target from the container sets obtained in step S901 (step S902). For the selected container set, layout calculation is executed. First, the sizes of the two containers (A and B) as flexible elements included in the selected container set are calculated assuming that the containers are not affected by the image size or text amount of data to be inserted. More specifically, the layout editing application 121 determines whether the container A is an image data container or text container. This determination can be done on the basis of the attribute set for the container, as described above. Next, the layout editing application 121 reads out the data to be inserted in the container A. When the container A is an image data container, the size (the number of horizontal pixels, the number of vertical pixels, and the resolution) of the image data is defined as the size of the container A without any constraint. When the container A is a text container, the amount of data to be inserted in the container A can be calculated on the basis of the number of characters of text data and the character attribute designated by the container attribute of the container A, such as a font type, font size, character pitch, and line pitch. For the text container, a constraint is applied because the aspect ratio of the container A cannot be determined without considering a constraint. In the example shown in FIG. 11, since anchors are set at the upper left and lower left corners of the container A, the height (vertical direction) is fixed. Hence, the layout editing application 121 determines whether characters corresponding to the calculated data amount (text amount) can be inserted in the container A having the width (horizontal direction) set as the basic pattern of the container A. If it is determined that all characters can be inserted, the size (width and height) set by the basic pattern does not change in the container A. If it is determined that not all characters can be inserted, the size is changed. In the example of FIG. 11, the container A expands in the horizontal direction because the height is fixed by setting the anchors. In this case, the layout editing application 121 calculates the width of the container A, which allows insertion of characters in the calculated amount, thereby calculating the size of the container A.

Next, the layout editing application 121 optimizes the layout such that the difference between the size of each container to be laid out and the actual contents size becomes as small as possible (step S903). The layout is optimized such that the difference between the size of the content to be inserted and the size of layout becomes as equal as possible between the containers associated with each other to dynamically change their sizes. The layout editing application 121 obtains the size of the container set selected in step S902, i.e., the total size of the container A, container B, and link 1106 (a fixed link in this case). Then, the layout editing application 121 calculates the difference between the total size and the size of the container set in the basic layout (in the example shown in FIG. 11, the size of the container set corresponds to the distance between the anchor icons of the containers A and B). If the width of the container A or B is increased by the calculation in the preceding step, a difference value is generated. The layout editing application 121 equally distributes the difference value to the elements of the container set, thereby adjusting the layout.

The layout editing application 121 optimizes the layout. If a violation of rules has occurred, calculation is executed again to prevent any violation of rules (step S904). The rules described here are constraints set by the user in creating the layout. Examples of the constraints are a constraint on the container size change range or container position, and for a flexible link, a constraint on the change in link length. When the layout is calculated without any violation of rules, the layout of the set is completed. The processing in steps S902 to S904 is executed for all sets on the page. With the processing, the layout editing application 121 calculates the layout of the entire page (step S905).

FIGS. 10A to 10C show a UI example in laying out containers without setting the priority order.

FIG. 10A shows a state in which records are inserted, and the layout is determined. Reference numerals 1001 and 1002 denote anchors; 1003 and 1004, fixed edges; 1005, a flexible edge: 1006, an arrow which indicates the change direction of a flexible edge; and 1008, a link. In this state, the records are changed, and contents having different sizes are inserted. Referring to FIG. 10B, the sizes of the new contents are superimposed on the state shown in FIG. 10A. Reference numeral 1009 denotes a size of the content to be inserted in each container. Layout calculation is executed. FIG. 10C shows the result of layout calculation. The sizes of the containers are calculated such that they have the same difference to the size of the content to be actually inserted, and no violation of the above-described rules occurs. As shown in FIG. 10C, the contents size (1009) to be inserted shown in FIG. 10B and a contents size (1010) after calculation have the same difference to the reference container size.

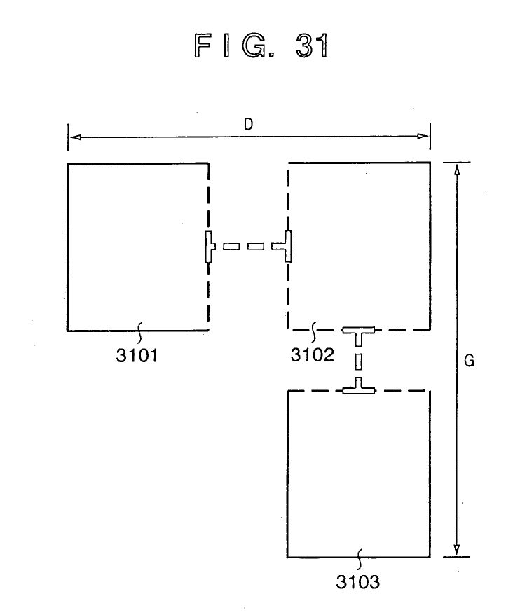

The layout calculation executed only in the horizontal direction as shown in FIGS. 10A to 10C is processing of executing the layout calculation with the same difference and causes no problem. The layout calculation in consideration of the vertical direction and the horizontal direction as shown in FIG. 31 cannot be done only by the layout calculation with the same difference.

In the case shown in FIG. 31 which deals with the two dimensional layout in the horizontal direction and the vertical direction, the layout is adjusted in the horizontal direction first, then in the vertical direction by using the layout calculation method shown in FIG. 9. More specifically, the layout is adjusted to be included in the set value D in the above-described procedure between containers 3101 and 3102, and then the layout is adjusted to be included in the set value G between containers 3102 and 3103.

An adjusting method for adjusting the layout in the horizontal direction and then in the vertical direction is assumed to result in a layout result which deviates from a basic layout desired by a user.

Therefore, the layout is adjusted so that each container does not depart from a basic pattern (the container size when the layout is designed or the aspect ratio of the container). For example, a method below can be considered. The sum of the square of a difference between the width of a basic pattern and the width after the layout adjustment and the square of a difference between the height of the basic pattern and the height after the layout adjustment is obtained for each of the containers. The layout editing application program 121 executes the layout adjustment by calculating a width and a height of each container so that the total sum of the squares of respective containers (horizontal direction+vertical direction) is the minimum. The method can determine the totally balanced final layout, which does not excessively deviate from the basic layout set by the user, by executing the layout adjustment with least squares as such.

A flexible link to be described later is set between containers. Therefore, the link size changes, as described later, according to the size of contents data to be inserted. The layout editing application program described in the present application can adjust the location where a plurality of partial display areas (containers) according to the allocated data size with such a layout adjustment unit.

Although a method of using a least square is exemplified as a layout adjustment algorithm in the above description, the layout adjustment algorithm can be switched by a predetermined operation of cube or biquadrate.

[Setting of Link with Flexible Length]

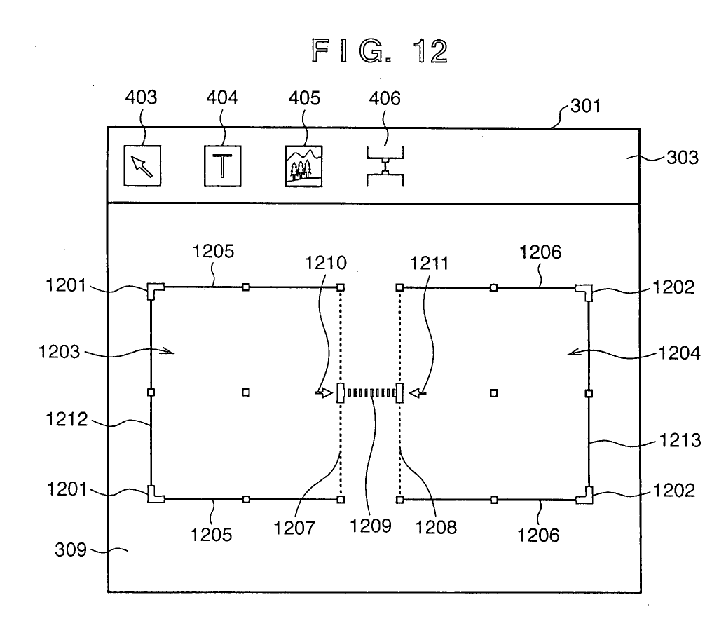

FIG. 12 shows a user interface to set a flexible link. As in FIG. 4, the user interface has the application window 301 and tool bar 303. In the state shown in FIG. 12, containers 1203 and 1204 are present on the document template 309. The containers include anchor icons 1201 and 1202 and fixed edges 1205 and 1206. A link 1209 having a flexible size is set between the containers 1203 and 1204 to connect them. Since the link is set between the containers 1203 and 1204, a right edge 1207 of the container 1203 and a left edge 1208 of the container 1204 are expressed by dotted lines. Hence, indicators 1210 and 1211 are displayed in the containers to indicate that the edges 1207 and 1208 are flexible.

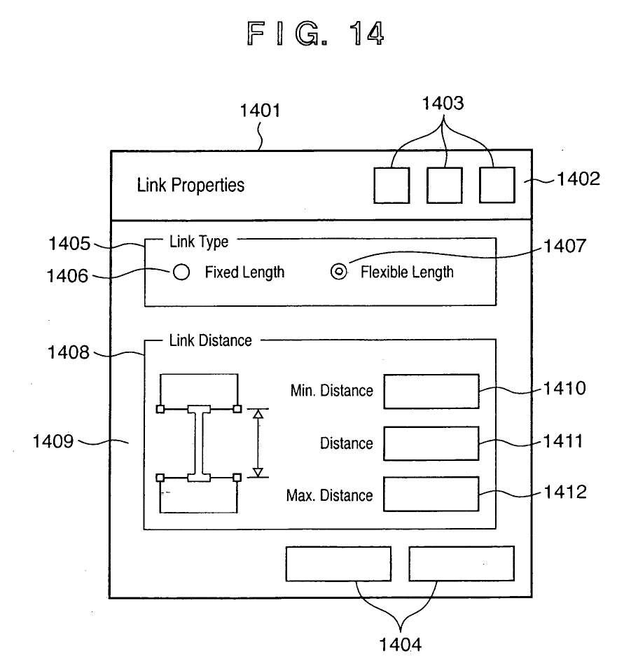

FIG. 14 shows a user interface window in the link setting means. FIG. 14 shows an example of a dialogue window 1401 to set the information of the link 1209. This dialogue includes a title bar 1402, a tool button 1403, a button 1404 to open/close the dialogue window, and an area 1409 to set various kinds of information. In this dialogue window, the link type can alternatively be selected from a flexible length (1407) and a fixed length (1406). When the link type is “flexible”, the minimum value (Min. Distance 1410), maximum value (Max. Distance 1412), and reference value (Distance 1411) of the link length can be set. The dialogue 1401 shown in FIG. 14 is displayed when a link is set between two containers by the link setting operation described with reference to FIGS. 6 and 7A to 7C, and the set link is selected by, e.g., a click operation. Alternatively, immediately after a link is set, the dialogue window 1401 related to the link may be displayed automatically. The reference value 1411 of the distance between the containers indicates a link length used when the size of each container does not change at the time of data insertion.

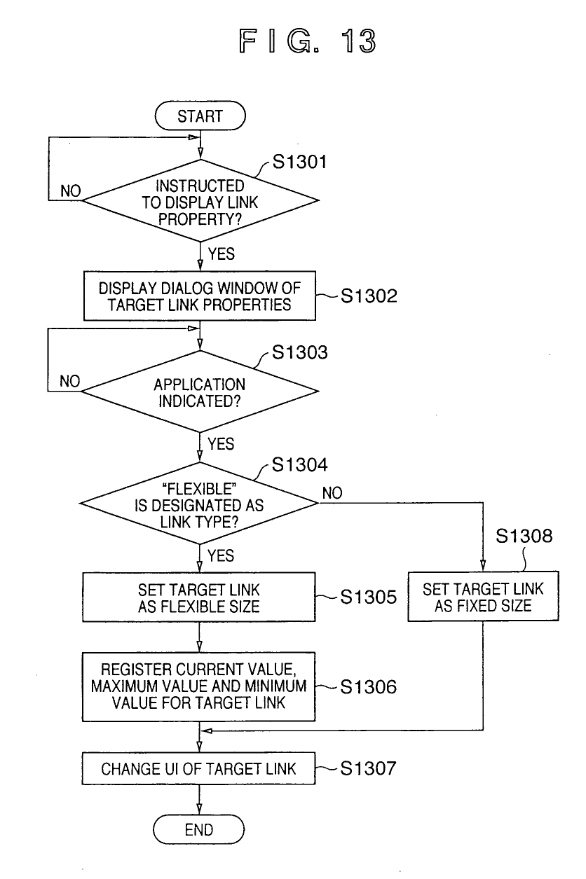

FIG. 13 is a flowchart for explaining flexible link setting procedures by the user interface 103 according to this embodiment. For example, when a link is set between, e.g., the containers A and B shown in FIG. 11 in accordance with the procedures described with reference to FIGS. 6 and 7A to 7C, a link with a fixed size is set first. When this link is selected, and processing shown in FIG. 13 is executed, the link can be changed from a link 1106 (FIG. 11) with a fixed size to a link 1209 (FIG. 12) with a flexible size.

First, a desired link (e.g., link 1106) is selected by the mouse, and a predetermined operation to display link properties is performed. The user interface 103 of the layout editing application 121 then recognizes the operation as input of a link property display instruction (step S1301). Upon recognizing the link property display instruction, the property dialogue window 1401 (FIG. 14) corresponding to the selected link (to be referred to as a target link hereinafter) is displayed. Next, the user interface 103 displays link properties (step S1302). A link can be selected by any operation such as clicking on the right button of the mouse or operating a specific key of the keyboard, like in setting the basic pattern of a container.

The current state of the selected link is shown in the dialogue window 1401 displayed in step S1302. In this example, since the link 1106 is selected, the link size is fixed at this step. As a Link Type 1405, the Fixed Length 1406 indicating a fixed length is selected.

In the dialogue window 1401, the Flexible Length 1407 is selected as the Link Type 1405 to change the link from the fixed size to the flexible size. Accordingly, the Max. Distance 1412, Min. Distance 1410, and Distance. 1411 arranged in a Link Distance 1408 are validated, and numerical values can be set. To set the flexible size of the link, the user sets the maximum value of the link length in the Max. Distance 1412, the minimum value in the Min. Distance 1410, and the current value in the Distance 1411.

When setting is ended, the user instructs application of the setting by clicking on the general dialogue window open/close button 1404. When the user interface 103 detects this instruction, the processing advances from step S1303 to step S1304 to reflect the set state on the target link.

In step S1304, the layout editing application 121 determines whether the target link has a fixed size or flexible size. When a fixed size is designated, the flow advances to step S1308 to set the target link to “fixed size”. In step S1307, the display state of the target link is changed to “solid line” representing “fixed link”.

If it is determined in step S1304 that a flexible size is designated, the flow advances to step S1305. The layout editing application 121 sets the target link to “flexible size”. In step S1306, the current value (reference value), maximum value, and minimum value of the target link set in the dialogue window 1401 are registered. In step S1307, the display state of the target link is changed to “dotted line” representing “flexible link”. As a result, the UI display of the link changes to the state indicated by the link 1209 in FIG. 12 (step S1306). The pieces of setting information of the dialogue window 1401 are stored in the memory.

As the current value set in the Distance 1411, the distance between the containers currently laid out may be input automatically as a default value.

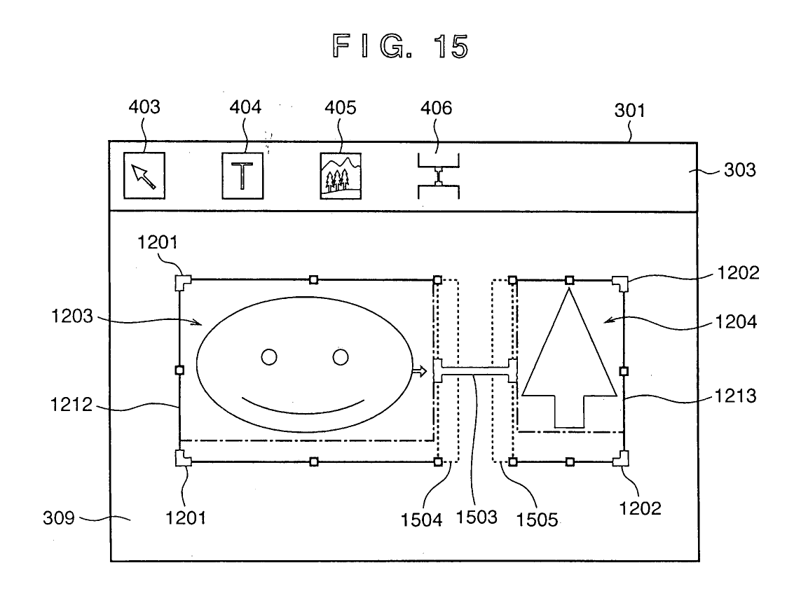

FIG. 15 shows a layout result when a fixed sized link is used and the contents are inserted into the basic layout described in FIG. 12. Although the link 1209 in FIG. 12 is a flexible link, it is assumed that a fixed link is set. Layout calculation method is executed in the above-described way.

For example, assume that image data (1504 and 1505) having different sizes are inserted in the containers 1203 and 1204 shown in FIG. 12.

In this case, each container regards the data size as optimum. The container 1203 changes its size rightward to a frame 1504 (optimum container size) corresponding to the size of the inserted image. Similarly, the container 1204 changes its size leftward to a frame 1505 (optimum container size) corresponding to the size of the inserted image.

However, the left edge 1212 of the container 1203 and the right edge 1213 of the container 1204 cannot be moved because of the anchors 1201 and 1202. To change the sizes of the containers, the distance between them must be shortened. However, a link 1503 having a fixed size is set between the containers. Since the link length is maintained in the layout calculation, the sizes of the containers 1203 and 1204 are changed.

As a consequence, the containers 1203 and 1204 cannot ensure the optimum sizes corresponding to the aspect ratios of the data. Finally, as shown in FIG. 15, the container sizes are smaller than the optimum sizes (frames 1504 and 1505). That is, since the size of the link 1503 is fixed, the containers 1203 and 1204 cannot achieve the optimum sizes (referring to FIG. 15, the range indicated by the alternate long and short dashed line in each container represents the aspect ratio of the data).

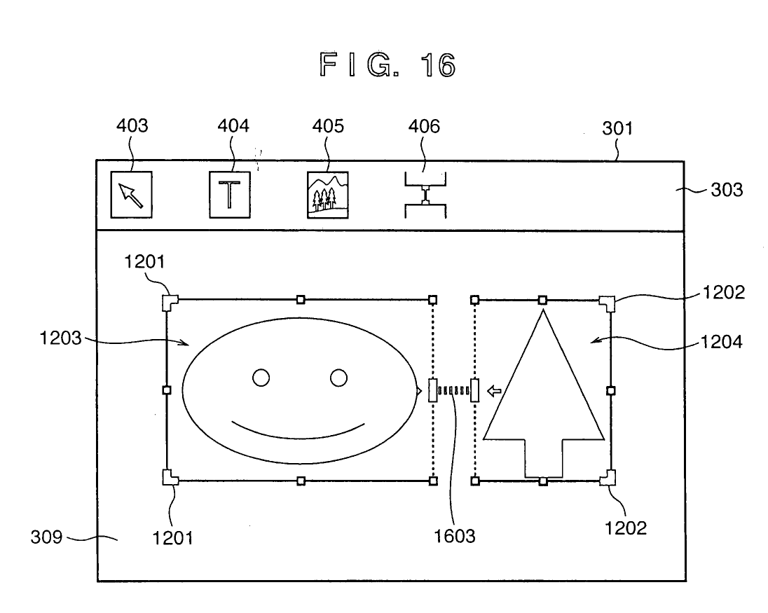

FIG. 16 shows the same case as in FIG. 15 except that the link has a flexible size. In this case, a link 1209 having a flexible size is set between the containers 1203 and 1204 of the above example, as shown in FIG. 16. Hence, when the sizes of the containers 1203 and 1204 are changed, the link size decreases so that the containers 1203 and 1204 can be larger than in the example shown in FIG. 15. As a result, optimum sizes corresponding to the inserted data sizes can be achieved. Alternatively, container frames close to the inserted data sizes (optimum sizes) can be set. FIG. 16 shows this result. The size of the flexible link 1209 changes to a size indicated by a flexible link 1603 as a result of layout calculation. In this case, the containers 1203 and 1204 have optimum sizes (sizes corresponding to the data sizes).

[Automatic Layout Processing with multiple types of Layout Calculation Method]

<Overall Flow>

Now, an automatic layout processing with multiple types of layout calculation method according to this embodiment will be described.

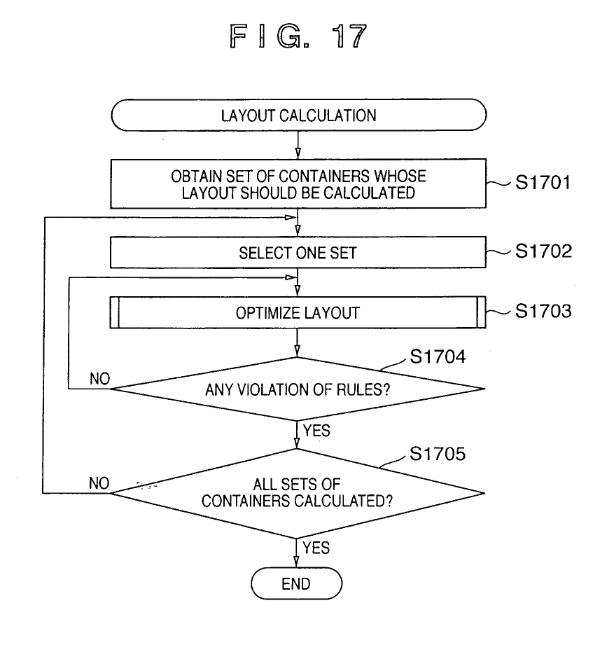

In this embodiment, an automatic layout processing for changing dynamically the layout of a document template, which includes a plurality of containers, according to the contents data to be inserted into each of the plurality of containers will be described. FIG. 17 is a flowchart showing an overall flow of automatic layout processing according to this embodiment. First, in step S1701, a set of containers, for which the layout is calculated, is obtained. The term “set of containers” here means a set including all the containers, which are directly or indirectly connected with each other by the link, as elements. The set of container is also called link set, indicating a group of containers associated with each other by the link as described above. As such, in step S1701, processing for finding a link set which is present in the overall layout is executed.

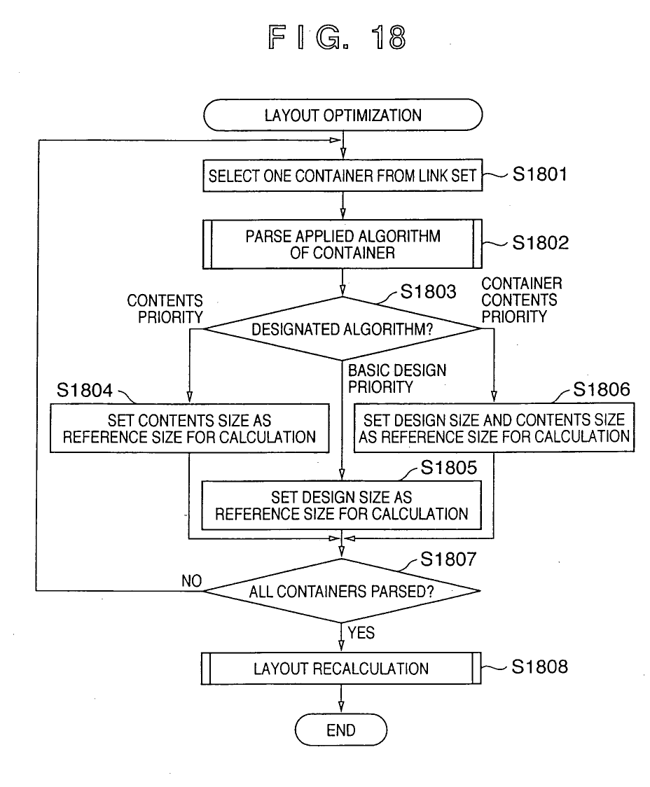

Next, in step S1702, one link set is selected from the link sets obtained in step S1701. In step S1703, the layout is optimized for the link set selected in step S1702. The optimization of the layout in step S1703 is equal to layout calculation. Processing of that optimization will be described in detail with reference to FIG. 18 in “Flow of optimizing layout”.

In step S1704, whether or not the rules are violated is checked. The term “rule” here means an offset rule, which is a constraint of the layout. The constraints of the layout intend to the maximum/minimum value for a container or flexible link or the location of a page frame. The constraints are rules which cannot be violated in executing the layout calculation. In other words, the layout calculation is executed within a range where an offset rule is not violated. If it is determined that the rules are violated in step S1704, the flow returns to step S1703, where the layout is optimized again. If it is determined that the rules are not violated, the flow advances from step S1704 to step S1705. In step S1705, it is determined whether the above-described processing (optimization of the layout) is ended for all the link sets found in step S1701. If any link set remains to be processed, the flow returns to step S1702, where another link set is selected and optimization of the layout is executed. If calculation finishes for all the sets of containers, the overall flow of the layout ends.

When the overall flow of the layout ends as such, the layout is displayed as a preview as shown in step S804 in FIG. 8 or outputted to outside as data to be printed.

[Flow of Optimizing Layout]

FIG. 18 is a flowchart for explaining layout optimization processing according to this embodiment. The optimizing layout processing of this embodiment will be described with reference to the figure.

First, in step S1801, the layout editing application program selects one container from a link set (set) selected in step S1702. Specifically, the layout editing application program can recognize which container of the document template is selected by recognizing a container selected by using a mouse via an input/output interface 143. The container selected in S1801 is temporarily held in the memory 136.

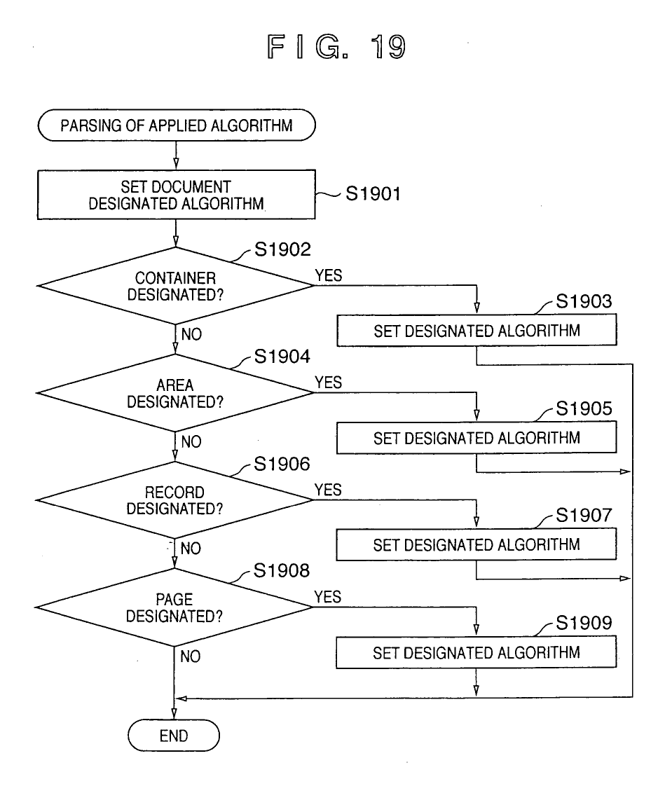

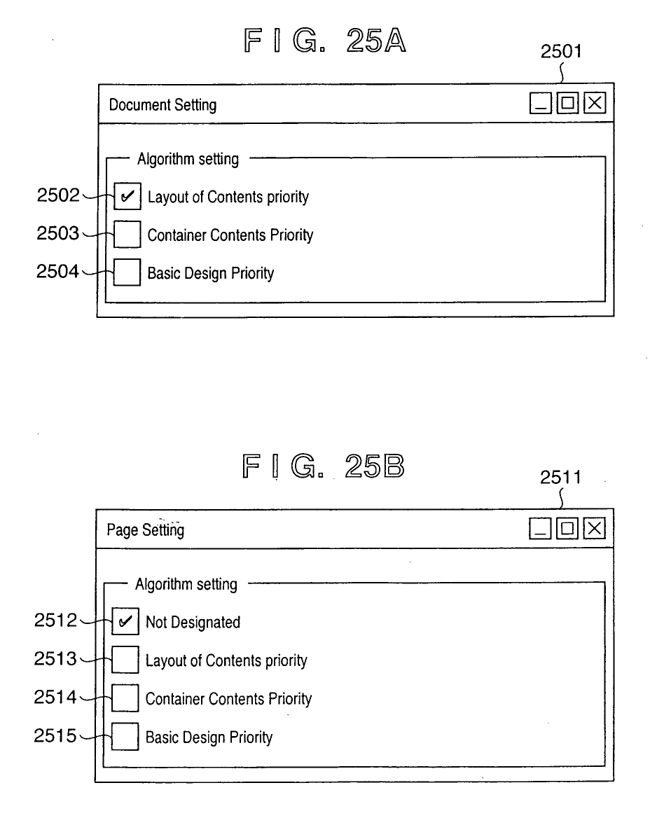

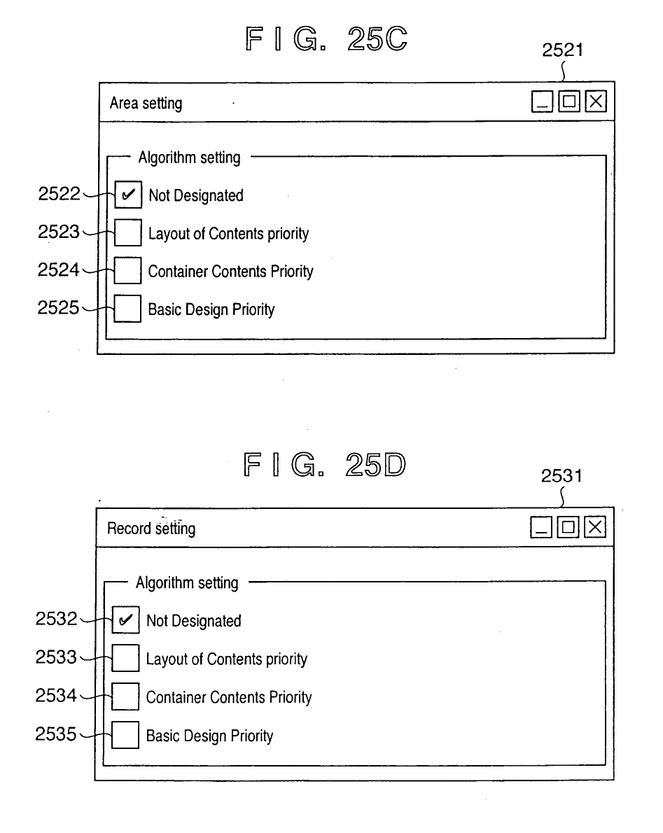

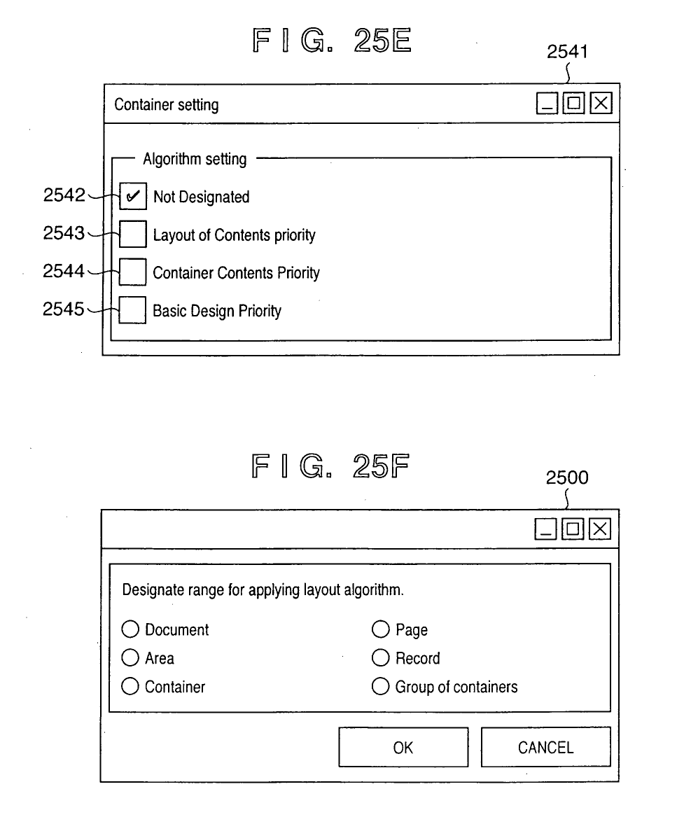

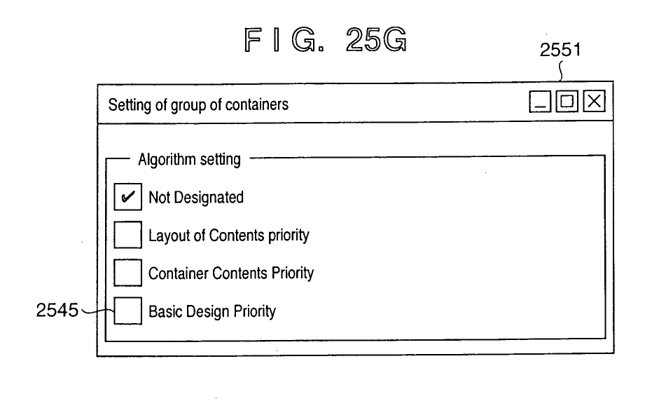

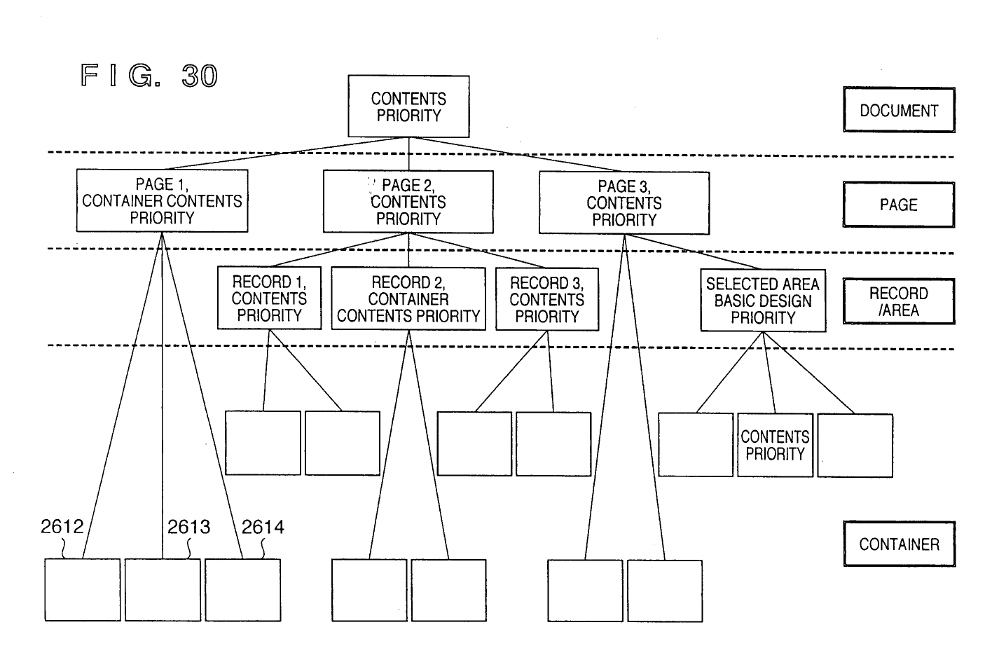

Next, in step S1802, the layout editing application program 121 obtains the layout adjustment algorithm to be applied to the container selected in S1801. The program obtains the layout adjustment algorithm by parsing (analyzing) algorithm information held in the memory 136 or the storage device 139. The layout adjustment algorithm information is set by using a user interface, which will be described later in FIG. 25 or the like, and held in the memory 136 or the storage device 139 as shown in FIG. 30 (described later), for example. Here, such layout adjustment algorithm information is searched and determined as the layout adjustment algorithm to be applied to execute the layout calculation for a container selected in step S1801. Processing in step S1802 will be described in detail with reference to FIG. 19 in “Flow of Parsing the Applied Algorithm”.

In step S1803, the layout editing application program 121 branches processing according to a searched result of the layout adjustment algorithm in step S1802. If the layout adjustment algorithm to be applied to the container selected in step S1801 is determined as “contents priority”, the flow advances from step S1803 to step S1804. In step S1804, the layout adjustment algorithm sets the size of the contents to be inserted into the container selected in step S1801 (data inserted from database) is a reference size for calculation for the container and temporarily holds the size in the memory 136. If the contents are an image, the size of the image data will be a reference size for calculation. If the contents are text data, a reference size for calculation is determined based on the number of characters and an attribute of a container, into which the text data is inserted (character attribute such as a font type and a font size to reflect the text data).

If the layout editing application program 121 determines that the applied layout adjustment algorithm for a container selected in step S1801 is “container-contents priority”, the flow advances to step S1805. In step S1805, the size of the container when the container selected in step S1801 is designed (at the time of basic layout) is set as a reference size for calculation of the container. Then, the set reference size for calculation is temporarily held in the memory 136 with the size of the contents to be inserted into the container (data inserted from database).

When the layout editing application program 121 determines that the applied layout adjustment algorithm for the container selected in step S1801 is “basic design priority”, the flow advances to step S1806. In step S1806, the design size of the container selected in step S1801 (container size at basic layout) is set as a reference size for calculation of the container and temporarily held in the memory 136. In the present application, a reference size for calculation is sometimes referred to as target form.

After completion of steps S1804 through S1806, the flow advances to step S1807, where it is checked whether the applied layout adjustment algorithm of all the containers is parsed. If any container remains to be parsed, the flow returns to step S1801, where another container is selected from the link set and the applied layout adjustment algorithm of the selected container is parsed. If it is determined that all the containers in the link set are parsed, the flow advances to step S1808, where the layout recalculation processing is executed. The term “layout recalculation processing” is processing for executing the layout calculation in each link set according to the applied layout adjustment algorithm. Processing in step S1808 will be described in detail in “Flow of Layout Recalculation Processing” later.

The layout editing application program 121 selects an layout adjustment algorithm to be applied to said data area from a plurality of layout adjustment algorithms.

And the layout editing application program 121 executes the layout processing according to selected layout adjustment algorithms.

[Flow of Parsing Applied Layout Adjustment Algorithm]

FIG. 19 is a flowchart showing parsing of an applied layout adjustment algorithm which is executed in step S1802 for a container selected in step S1801. First, in step S1901, the layout editing application program 121 sets a document specifying algorithm to the applied layout adjustment algorithm of the container. More specifically, the layout adjustment algorithm set for a document as default setting is set as the applied algorithm for the container for a while. For example, in the layout adjustment algorithm information as shown in FIG. 30, the layout adjustment algorithm called “contents priority” set for a document layer is set.

Next, in step S1902, the layout editing application program 121 checks whether any layout adjustment algorithm directly designated for a container is present. Specifically, as the memory 136 holds container attribute, the layout editing application program 121 can determine whether any directly designated layout adjustment algorithm is present or not by referencing the memory 136.

When the layout editing application program 121 determines that a layout adjustment algorithm directly designated for a container is present in S1902, the flow advances to step S1903, where the designated algorithm is set for the container and this parsing processing is ended.

If no layout adjustment algorithm directly designated for the container is present, the flow advances to step S1904. In step S1904, the layout editing application program 121 checks whether any layout adjustment algorithm is designated for an area including the container or not (a certain range). The term “area” here can define a range which a user arbitrarily selected or a link set (set) explained in FIG. 18. If the layout editing application program 121 determines that a layout adjustment algorithm designated for the area is present, the flow advances to step S1905, where the designated algorithm is set for the container in the area and the parsing processing is ended. If the layout adjustment algorithms are designated for the area, information on the algorithms is also held in the memory 136, thus, determination in step S1904 can be done by the layout editing application program 121 referencing the memory 136.

If no layout adjustment algorithm designated for the area is present, the flow advances to step S1906. In step S1906, the layout editing application program 121 checks whether the layout adjustment algorithm to be used is designated in a record which includes contents data to be inserted into the container. For example, the layout adjustment algorithms to be used for the layout calculation can be changed by record such that a certain layout adjustment algorithm in a record 1 and another layout adjustment algorithm in a record 2. If the layout adjustment algorithms to be used by record are designated, information on the algorithms is also held in the memory 136. Therefore, determination in step S1906 can be executed by the layout editing application program 121 referencing the memory 136.

If the layout adjustment algorithm designated for a record is present, the flow advances to step S1907, where an algorithm designated for the current record is set for the container and parsing processing is ended.

If no layout adjustment algorithm designated for a record is present, the flow advances to step S1908. In step S1908, the layout editing application program 121 checks whether the layout adjustment algorithm to be used in a page including the container is designated. The term “in a page” here means setting to apply to all the containers on the page and a different layout adjustment algorithm for each page can be designated. If the layout adjustment algorithms to be used are designated by page, information on the algorithms is also held in the memory 136 and determination in S1906 can be executed by the layout editing application program 121 referencing the memory 136. If the layout adjustment algorithms designated for a page is present, the flow advances to step S1909, where an algorithm designated for the current page is set for the container and parsing processing is ended. If it is determined that no layout adjustment algorithm designated for a page is present in step S1908, it is determined No in determination processing of S1902, S1904, S1906 and S1908. In such a case, the layout editing application program 121 applies a document specifying algorithm set in S1901 for the container in the document, and the flow is ended.

With above-described parsing processing, a state set for a lower layer in a layer structure shown in FIG. 30 is preferentially set for the container.

[Recalculation Processing Flow]

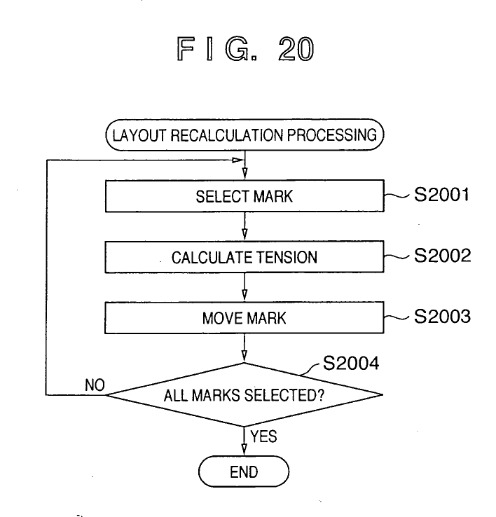

FIG. 20 is a flowchart showing layout recalculation processing (step S1808) according to this embodiment.

First, in step S2001, the layout editing application program 121 selects a mark. The term “mark” means frame lines of containers, which are selected to determine which side of the container to be moved. The frame lines selected here is a side of a container which can be moved.

In step S2002, the layout editing application program 121 calculates a tension. The term “tension” corresponds to a difference between a reference size for calculation and the current container size. A calculation method of a difference between a reference size for calculation and the current container size differs for each layout adjustment algorithm. The layout calculation determines the layout by reducing the difference (lowering the tension). As described above, the reference size for calculation depends on the applied layout adjustment algorithm and is temporarily held in the memory 136. Further, as the current container size is also temporarily held in the memory 136, the layout editing application program can calculate a tension by referencing the memory 136 in S2002.

In step S2003, the layout editing application program 121 moves a mark based on the tension calculated in step S2002. Information on the location after the movement (coordinate value or the like) and the fact that the mark is moved are held in the memory 136.

Whether all the marks are selected or not is checked in step S2004. The term “all the marks” means edges (frames) of all the containers. Whether the marks are moved is determined by tension calculation for all the containers in a link set. As the memory 136 holds that movement processing ends for the containers whose marks are moved in S2003, the layout editing application program can determine whether all the marks are selected or not by referencing the memory 136. If any mark remains to be selected, the flow advances to step S2001, where the unselected mark is selected and processing after step S2002 is repeated. If all the marks are selected, the flow is ended.

[Calculation Method of Respective Layout Adjustment Algorithms]

Next, calculation methods of some layout adjustment algorithms executed in steps S2002 and S2003 will be described. Although the layout adjustment is executed on a container in one direction (horizontal direction) in the following description, the layout adjustment is executed in the same manner as in the vertical direction. It is apparent that the processing can be extended to execute the layout adjustment on the container in both directions (vertical and horizontal directions). As an algorithm calculation method, the above-described method of using least squares can be included. The layout adjustment algorithm for adjusting the layout of containers is not limited to what described in this embodiment.

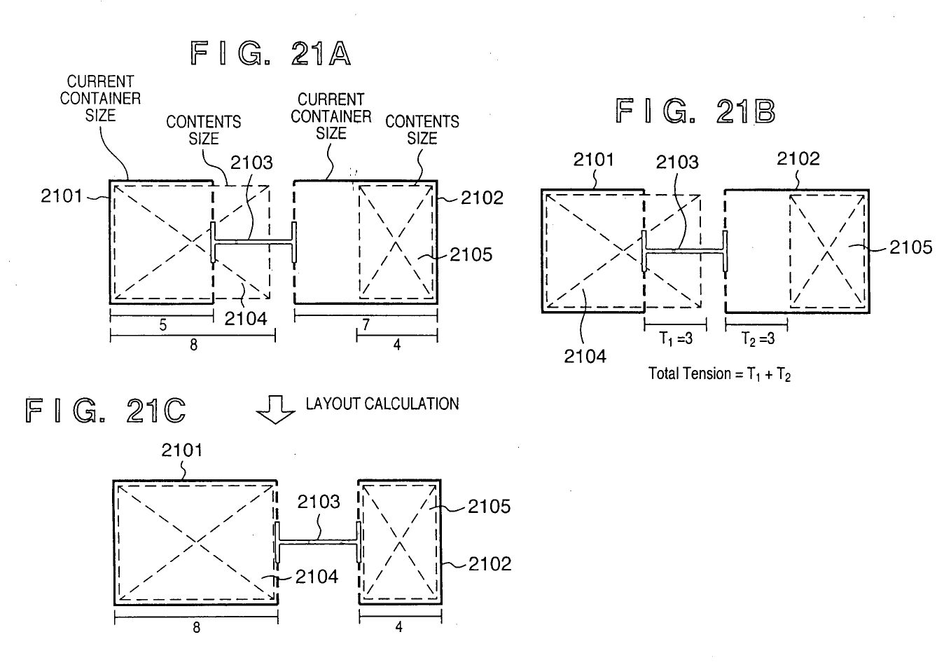

FIGS. 21A to 21C are diagrams for explaining layout adjustment algorithm of contents priority. As shown in FIG. 21A, a container 2101 and a container 2102 are present, being associated with each other by a link 2103. Each of the containers has data (contents) inserted from database, with contents 2104 inserted in the container 2101 and contents 2105 inserted in the container 2102. The width sizes of the current containers (the width size of a container before the contents 2104 and the contents 2105 are inserted) are; for the container 2101 and 7 for the container 2102. The width sizes in contents sizes are; 8 for the contents 2104 and 4 for the contents 2105.

The layout adjustment algorithm of contents priority executes the layout calculation based on the information. The layout adjustment algorithm of contents priority executes the layout adjustment on the container size by considering the contents size as a reference size for calculation in the above-described manner. The layout calculation brings the current container size near to the reference size for calculation by executing the layout adjustment on the current container to reduce a difference (tension) between the current container size (container 2101, container 2102) and a reference size for calculation (contents 2104, contents 2105).

FIG. 21B shows calculation processing of a tension. As shown in FIG. 21B, a tension T₁ of the container 2101 is 8−5=3 and a tension T₂ of the container 2102 is 7−4=3. Therefore, the sum of tensions in the link set is 6.

FIG. 21C shows a result of moving marks to reduce a tension. Here, the size of the container 2102 is 8 and the size of the container 2102 is 4, both are attaining reference size for calculations respectively (the size of contents 2104 is 8 and the size of the contents 2105 is 4). Accordingly, the tension of the layout result by the layout calculation is 0. When the layout adjustment algorithm of contents priority is used, the container size is determined by giving priority to the size of the contents.

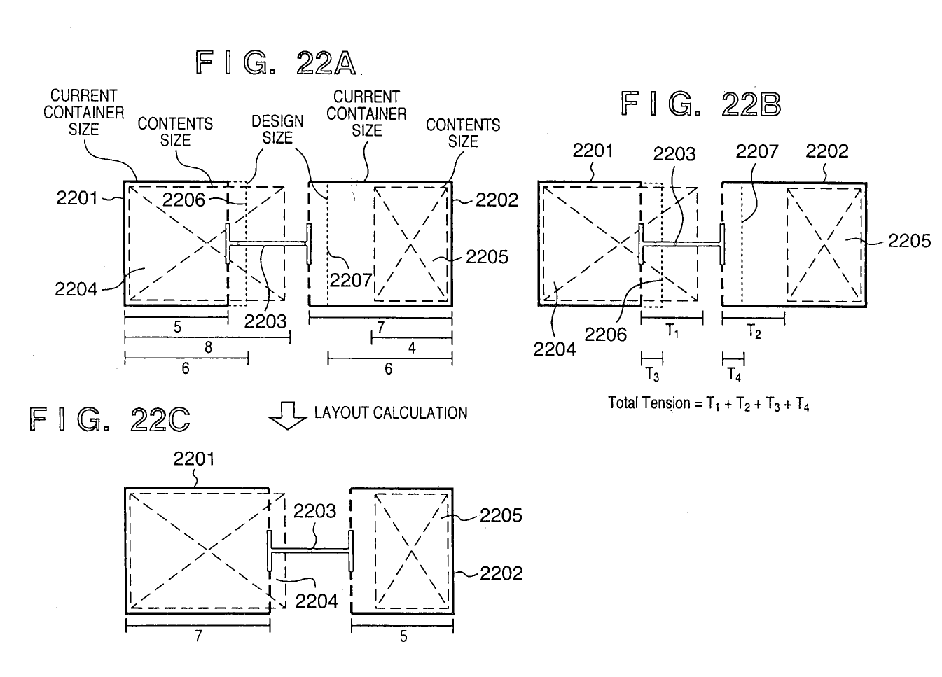

FIGS. 22A to 22C are diagrams for explaining layout adjustment algorithm of container-contents priority. The term “design” means a state where a user creates a container or a link in a layout creating mode (basic layout). The design size is a size of such an object when it is created (at being designed).

As shown in FIG. 22A, the container 2201 and the container 2202 are present, being associated with each other by the link 2203. Each of the containers has data (contents) inserted from database, with contents 2204 inserted in the container 2201 and contents 2205 inserted in the container 2202. The width sizes of the current containers (the size before the contents 2204 and the contents 2205 are inserted) are; 5 for the container 2201 and 7 for the container 2202. The width sizes in contents sizes are; 8 for the contents 2204 and 4 for the contents 2205. The container size at being designed 2206 and 2207 are also present.

In the example of FIG. 22A, a user sets 6 for the width size of the container 2201 and the container 2202 as a basic layout. When the contents data in the first record is inserted; the layout calculation is executed and the container sizes are changed to the current sizes (5 for the container 2101 and 7 for the container 2202).

FIG. 22A shows the state where a record, on which the layout calculation is executed, is further inserted by using the layout adjustment algorithm of container-contents priority in the above-described state.

The layout adjustment algorithm of container-contents priority executes the layout calculation in consideration of the contents size and the current container size and the container size at being designed (at the time of basic layout). The layout adjustment algorithm of container-contents priority executes the layout adjustment on the container size as considering the design size added to the above-described contents size as a reference size for calculation. More specifically, the layout calculation brings the current container size near to the reference size for calculation by executing the layout adjustment on the current container to reduce a difference (tension) between the current container size (container 2201 and the container 2202) and the contents size (contents 2204, contents 2205) and a difference between the current container size (container 2201 and the container 2202) and the design size (design size 2206 and design size 2207).

FIG. 22B shows calculation processing of a tension. A tension of each container is as below:

For the container 2201, a tension (T₁) between the contents size and the current container size is |8−5|32 3 and a tension (T₃) between the design size and the current container size is |5−6|=1. For the container 2202, a tension (T₂) between the contents size and the current container size is |4−7|=3 and a tension (T₄) between the design size and the current container size is |6−7|=1. Therefore, the sum of the tensions in the link set is 3+1+3+1=8.

FIG. 22C shows a state of the result of moving marks to reduce a tension.

Here, the size of the container 2201 is 7 and the size of the container 2202 is 5. Accordingly, the tensions resulted from the layout are; a tension (T₁) to the container 2201 from the contents size is |8−7|=1 and a tension (T₃) from the design size is |6−7|=1; and a tension (T₂) to the container 2202 from the contents size is |4−5|=1 and a tension (T₄) from the design size is |6−5|=1. Therefore, the sum of the tensions in the link set is 1+1+1+1=4. Although the state of tension 0 is not achieved in this case, the layout calculation is ended here as no calculation method can further reduce the tension.

As such, the contents size and the design size are generally different sizes. When the layout adjustment is executed on the container to meet both of the contents size and the design size, tensions generally is not 0. Therefore, marks are moved so as to minimize the tension and the layout is determined. When the layout adjustment algorithm of container-contents priority is used, a layout result taking account of both the size of the contents and the container size at being designed can be obtained.

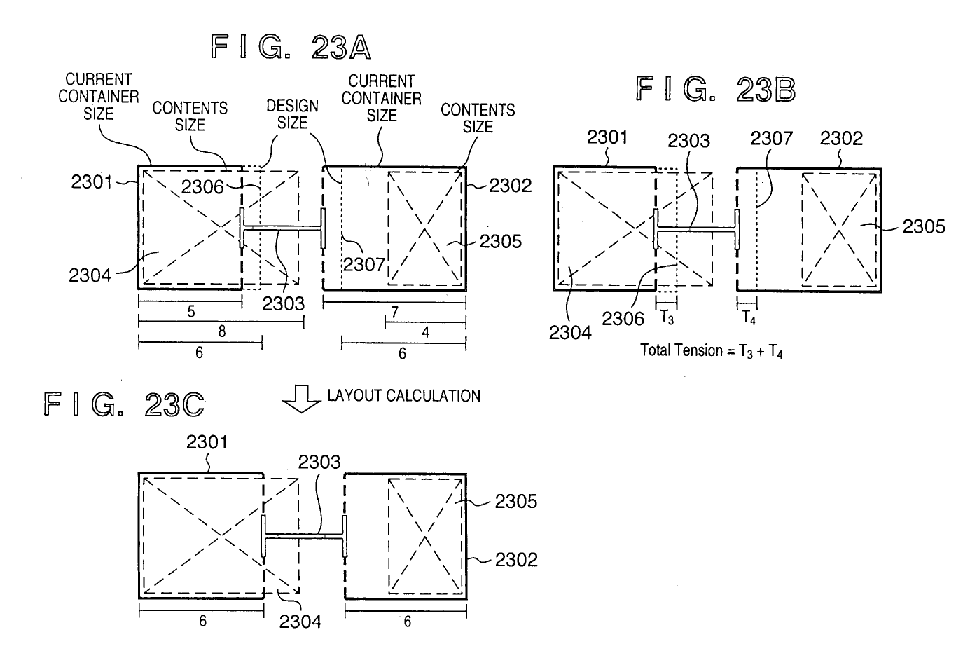

FIGS. 23A to 23C are diagrams for explaining layout adjustment algorithm of basic design priority. The term “basic design priority” in this embodiment means a method of executing the layout calculation with considering only the size at being designed as the reference size for calculation.

As shown in FIG. 23A, the container 2301 and the container 2302 are present, being associated with each other by the link 2303. Each of the containers has data (contents) inserted from database, with contents 2304 inserted in the container 2301 and contents 2305 inserted in the container 2302. The width sizes of the current containers (the width size of respective containers before the contents 2304 and the contents 2305 are inserted) are; 5 for the container 2301 and 7 for the container 2302. The width sizes in contents sizes are; 8 for the contents 2304 and 4 for the contents 2305. The container sizes 2306 and 2307 at being designed (basic layout) are also present. The container sizes 2306 and 2307 at being designed are 6.

The layout adjustment algorithm of basic design priority executes the layout adjustment on the container based on information on the current container size and the design size of the above-described information. Accordingly, the layout calculation brings the current container size near to the reference size for calculation by executing the layout adjustment on the current container to reduce a difference (tension) between the current container size (container 2301, container 2302) and a reference size for calculation (design size 2306, design size 2307).

FIG. 23B shows a state where a tension is calculated. Now, as a tension to a container, a tension (T₃) to the container 2311 from the reference size for calculation is 6−5=1. A tension (T₄) to the container 2312 from the reference size for calculation is 7−6=1. Therefore, the sum of the tensions in the link set is 1+1=2.

FIG. 23C explains the result of moving marks to reduce the above-described tension, with states of the containers 2301 and 2302 and the contents 2304 and 2305 after adjustment. Here, the size of the container 2301 is 6 and the size of the container 2302 is 6. Tensions resulted from the layout are; a tension to the container 2301 from the reference size for calculation is 6−6=0 and a tension to the container 2302 from the reference size for calculation is 6−6=0. Therefore, the sum of the tensions in the link set is 0+0=0. The reference size for calculation is achieved in the layout result.

When the layout adjustment algorithm of basic design priority is used, the container size is determined as priority is given to the size of the contents at being designed by a user, regardless of the size of the contents.

As the layout adjustment algorithm has no relationship to the size of the contents, it has no flexible element in the layout calculation. That is to say, the container is always in the size of being designed. Accordingly, the layout adjustment algorithm of basic design priority works when it is used with another layout adjustment algorithm in a link set.

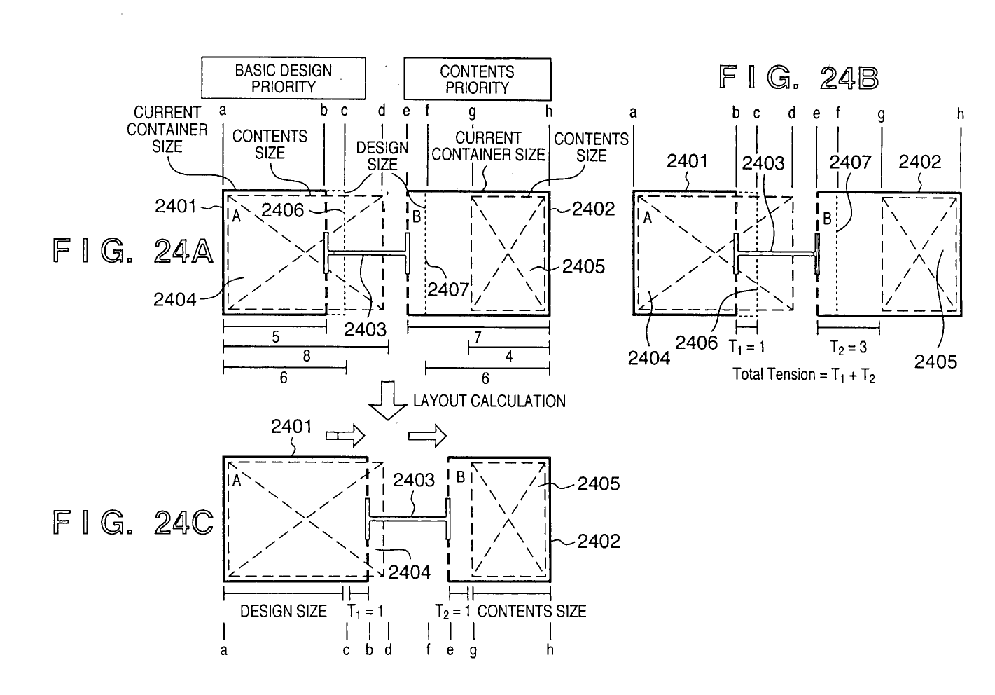

FIGS. 24A to 24C are diagrams for explaining layout calculation processing when a layout adjustment algorithm of basic design priority and a layout adjustment algorithm of contents priority are set in different containers in a link set.

As shown in FIG. 24A, the container 2401 and the container 2402 are present, being associated with each other by the link 2403. The basic design priority is set for the container 2401 and the contents priority is set for the container 2402. Each of the containers has data (contents) inserted from database, with contents 2404 inserted in the container 2401 and contents 2405 inserted in the container 2402. The width sizes of the current containers are; |a−b|=5 for the container 2401 and |e−h|=7 for the container 2402. The width sizes in contents sizes are; |a−d|=8 for the contents 2404 and |g−h|=4 for the contents 2405. The container sizes 2406 and 2407 at being designed are also present. Both of the container sizes at being designed 2406 and 2407 are 6.

As shown in FIG. 24B, the layout adjustment algorithm set for the container 2401 is basic design priority. Accordingly, in the layout calculation, a difference (tension T₁) between the current container size (container 2401) and the design size (design size 2406) are used. As the layout adjustment algorithm of contents priority is set for the container 2402, a difference (tension T₂) between the current container size (container 2402) and the contents size (contents 2405) are used. The layout calculation brings the current container near to the reference size for calculation by reducing the tensions and executing the layout adjustment on the current container.

In FIG. 24B, a tension to the container 2401 is a tension T₁ between the design size (6) and the current container size (5) of the container 2401=|b−c|=1. A tension to the container 2402 is a tension T₂ between the current container size (7) and the contents size (4)=|e−g|=3. Therefore, the sum of the tensions in the link set is T₁+T₂=|b−c|+|e−g=4.

FIG. 24C shows a result of moving marks to reduce the above-described tension. Here, the size of the container 2401 is |a−b|=7 and the size of the container 2402 is |e−h=5. As a result of the layout, a tension to the container 2401 is a tension T₁ between the design size (6) and the current container size (7)=|b−c|=1. A tension to the container 2402 is a tension T₂ between the current container size (5) and the contents size (4)=|e−g|=1. Therefore, the sum of the tensions in the link set is T₁+T₂₌₂. Although the state of tension 0 is not achieved in this case, the layout calculation is ended here as the tension cannot be further reduced. In this manner, the layout is done with the size (7) of the container 2401 in FIG. 24C being laid out near to the size at being designed (6) and the size (5) of the container 2402 in FIG. 24C is laid out near to the size of the inserted contents (4).

As such, the layout adjustment algorithm of basic design priority works when it is used with another layout adjustment algorithm. The embodiment can serve various needs from a user in the layout by applying various layout adjustment algorithms to respective containers. Although a combination of basic design priority and contents priority is described above, it is a matter of course that another combination is also possible. Even if three containers or more are present in a link set, the calculation processing only needs to be executed as that described above for two containers.

Subsequently, calculation method on respective layout algorithms will be described. The layout algorithm hereof is set for flexible containers. Since the fixed containers give rise to no change in container size even if any layout algorithm is applied, they will not undergo execution of layout change processing even in the case where the layout algorithm hereof is applied. A fixed container may give rise to a possibility of undergoing changes in layout position in case of having been connected to the flexible container with the link.

[First Layout Algorithm (in Consideration of Contents Size)]

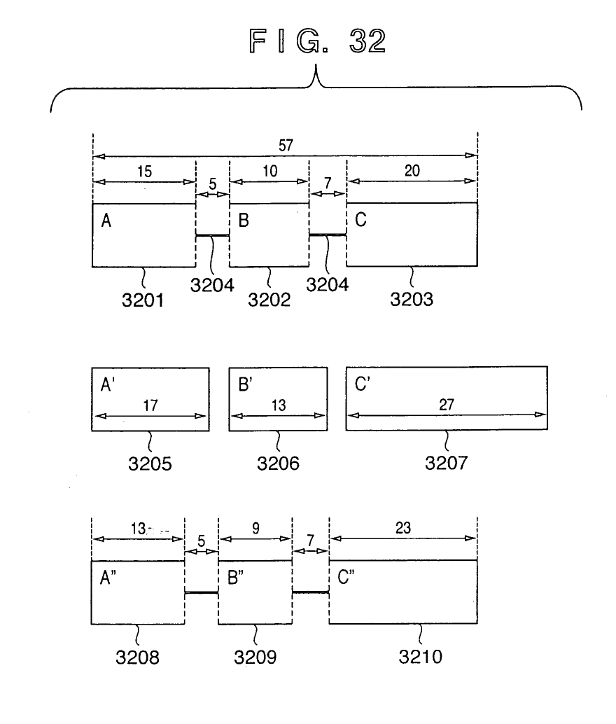

A first layout algorithm will be described with reference to FIG. 32. The first layout algorithm refers to “contents-prioritized layout algorithm” since it calculates contents sizes as reference size for calculation. In FIG. 32, reference numerals 3201 to 3203 denote basic containers at the time of designing. Reference numerals 3205 to 3207 denote contents to be inserted to respective containers. In addition, reference numeral 3204 denotes a link for associating respective containers and the link in FIG. 32 shall be a fixed link. In addition, reference numerals 3208 to 3210 denote a result subject to application of the first layout algorithm (contents-prioritized layout algorithm).

The containers A 3201, B 3202 and C 303 are associated by fixed link 3204. The containers and links have horizontal sizes as shown in the drawing. The total horizontal size is 57. In this Layout, positions of the left edge of the container A and the right edge of the container C are set so as to be fixed. Therefore, the value of 57 in total in the horizontal direction is fixed. When contents A′ 3205, B′ 3206, and C′ 3207 are inserted in the respective containers, tension (layout load) is generated in this layout.

Respective contents have real sizes. Suppose real sizes of contents shall be as shown in the drawing (17 for the contents A′, 13 for the contents B′ and 27 for the contents C′, respectively). When a content is a text, reference size for calculation is determined on the basis of the font size and the variable/fixed properties and maximum/minimum values of the horizontal and vertical sizes and the like set for the container to insert the data. When a content is an image, the real size equals to the size (the number of vertical and horizontal pixels) of the image data. To lay out all the contents inserted in the containers in real sizes, a horizontal size of 17+5+13+7+27=69 is necessary. However, the horizontal size of this layout is fixed to 57. Accordingly, 69−57=12 will become tension to be applied to this layout.

Next, the above described stress is distributed to the containers. The layout algorithm hereof is to calculate so that this tension will be balanced between respective containers, and an example of the technique to be used then is the least-squares method. At first, the method of calculating the tension of respective containers in the first layout algorithm shall be
T=layout-resulted size−contents size (1)
Since the value of tension will not always become positive, use of absolute value Is required.

And, the total of tension T calculated for respective containers by using equation (1) will become the total tension of the present target set. This will be described with reference to FIG. 32.

Let a, b, and c be the container sizes after calculation. In order to distribute the tension generated in respective containers appropriately, it is desirable to implement calculation processing of
t=(a−17)²+(b−13)²+(c−27)² (2)
Here, reference character “t” denotes a variable for calculating a value to balance the tension in respective containers. The case where this variable t is the minimum value is a state where the tension in respective containers is balanced.

Since the layout in FIG. 32 is a simple layout and no priority is set, even without using equation (2), the variable t is minimized when
|a−17|=|b−13|=|c−27| (3)
The layout size after calculation is given by
a+5+b+7c=57 (4)

The size of each container after calculation is obtained from equations (3) and (4). Here, a=13, b=9 and c=23 were derived from calculation. Accordingly, difference between the contents and the calculation results become 4, which is the difference of respective contents. That is, the tension applied to each container is 4. After calculation, containers A″, B″, and C″ (3208 to 3210) have the sizes as shown in the drawing.

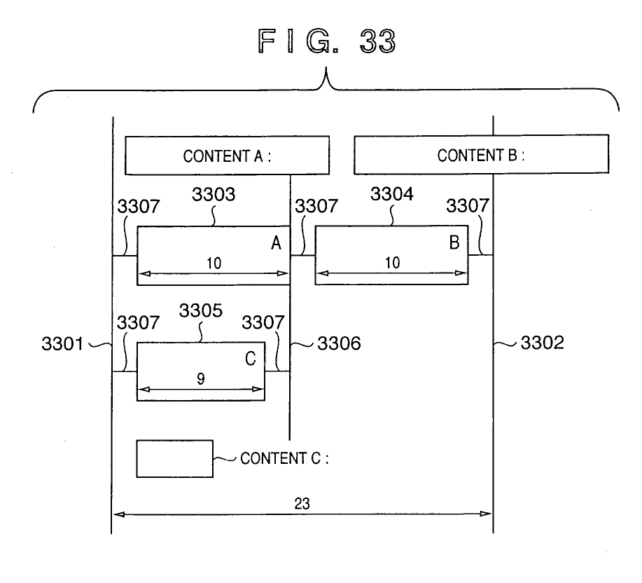

However, in case of FIG. 32, since equations (3) and (4) are used for calculation, a layout result can be calculated without using the least-squares method described in equation (2). This is resulted from the layout in FIG. 32 being a simple layout. That is, for some generated templates, it is desirable to use the least-squares method of equation (2). An example thereof will be described with reference to FIG. 33.

In the layout as in FIG. 33, a layout calculation method and a result in the case where the least-squares method has been used as well as a layout calculation method and a result in the case where the least-squares method has not been used are described. In FIG. 33, let contents with the size 15 be inputted to the container A, contents with the size 25 to the container B and contents with the size 5 to the container C. Let the present container size be 10 for size of the containers A and B and 9 for the size of the container C. In the present description, since the first layout algorithm is targeted, a reference size of calculation will become the contents size. The distance from the container 3301 to the container 3302 is 23. In FIG. 33, since the left edge of the container A and the right edge of the container B are assumed to be set so as to be fixed, the distance from the container 3301 to the container 3302 will be fixed. The size of the fixed link 3307 for associating respective containers is 1.

(1) Case without Using Least-Squares Method

In case of using for least-squares method, the container size of layout calculation result for each container is determined whether or not to get larger than the reference size for calculation. In case of FIG. 33, it is necessary to consider layout position and constraints (the containers 3301 and 3302 are fixed) and moreover contents size of each container. Since the container A is fixed at the left edge and is variable at the right edge, rightward size change as well as movement is feasible. Moreover, the total value (=35) of the contents size inserted in the container A 3303 and the container B 3304 will get larger than the above described constraints (distance between containers 3301 and 3302=23). That is, respective contents data inserted in the containers A and B are determined to have to be reduced. Accordingly, the size a of the container A after layout calculation can be determined to get smaller than the reference size for calculation (=15). In the similar manner, by analyzing the container B, the container B can be determined to get smaller than the reference size for calculation (=25).

On the other hand, as for the container C, the container size after layout calculation cannot be predicted only from the present layout positions, constraints and contents size. Accordingly, for the Layout in FIG. 33, layout calculation for the case where the size after calculation gets larger than the reference size for calculation (size of the contents C=5) and for the case where it gets smaller must be carried out.

At first, the case where the size of a calculation result of the container C gets larger than the reference size for calculation is set to consider. In addition, |layout result−reference size for calculation| is used as calculating equation on tension for respective containers. Here, the layout results of respective containers are a, b and c respectively. Moreover, in FIG. 33, reference numeral 3306 denotes an axis. Therefore, in case of a Layout in FIG. 33, the layout engine hereof calculates a layout result based on information at the time point where the tension generated in the container A and the container C present in the left edge of this axis 3306 as a border equals to the tension generated in the container B present in the right edge. An equation is created based on the description so far as follows:
|a−15|+|c−5|=|b−25| (condition: c>5) (5).

In the Layout in FIG. 33, a sum of the size of the layout size of the container A and one fixed link equals to the size of the layout size of the container C and the size of two fixed links. Moreover, the distance between the container 3301 and the container 3302 is fixed. As a result of taking the above into consideration, constrains are generated as follows:
a+1=1+c+1 (6)
1+a+1+b+1=23 (7).
Taking the above described conditions into account, equation (5) undergoes calculation processing, resulting in:
15−a+c−5=25−b
15−a+(a−1)−5=25−(−a+20)
a=4.

Moreover, with the calculation result and the equations (6) and (7), b=16 and c=3 are calculated. However, the condition in equation (5) is c>5. That is, since the calculation result c (=3) does not fulfill the condition of the equation (5), equation (5) collapses.

Subsequently, at first, the case where the calculation result of the container C gets smaller than the reference size for calculation is set to consider. Also in this case, since it is necessary to equalize tension on the left side and the right side of the axis 3306 as border, equation (5) can be used, but there is difference in condition. That equation is shown in the equation (8).
|a−15|+|c−5|=|b−25| (condition: c<5) (8).

Taking equations (6) and (7) into account, equation (8) undergoes calculation processing, resulting in:
15−a+5−c=25−b
15−a+5−(a−1)=25−(−a+20)
a=5.3

Moreover, with the calculation result and the equations (6) and (7), b=14.6 . . . and c=4.3 . . . are calculated. In this case, since the condition in equation (8) is fulfilled (c<5), a value calculated by equation (8) will become the layout result. Herein, the value rounded with regard to the first decimal place and smaller shall be the layout result, which will not be limited thereto.

(2) Case in Use of Least-Squares Method

Subsequently, a case in use of the least-squares method will be described. The case in use of the least-squares method will be described with reference to FIG. 33 as well, and its basic conditions are the same. At first, a calculation equation for layout calculation is created with the least-squares method:
t=(a−15)²+(b−25)²+(c−5)² (9)
Moreover, equation (9) is transformed with equations (6) and (7), resulting in
t=(a−15)²+{(−a+20)−25}²+{(a−1)5}² (10).

An object of the present layout algorithm is to minimize the variable t. Equation (10) is a quadric on a, the minimum value in the quadric with positive inclination is the value of the vertex. That is, it is adapted to the value with which equation (10) contacts the line with inclination of 0. Accordingly, setting the inclination to 0, equation (10) undergoes differentiation with a, deriving the calculation equation:
0=2(a−15)−2(−a−5)+2(a−6).
This calculation equation is solved to derive a=5.3. Moreover, the calculation result a is substituted into equations (6) and (7) to derive b=4.3 and c=14.7.

That is, the layout result calculated by using the least-squares method and the layout result calculated without using the least-squares method are the same. However, unless the least-squares method is used, calculation processing is implemented on case classification, load of processing related to layout calculation increases. On the other hand, in the case in use of the least-squares method, since no case classification is required, it will become possible to calculate a layout result without difficulty. Thus, in case of calculating a layout result for a complicated layout as in FIG. 33, it is meaningful to use the least-squares method. In addition, in FIG. 33, since the axis 3306 is one, division into two cases enabled calculation of a layout result, but as the axis increases, conditions for divided cases increase and therefore effectiveness of the least-squares method increases.

In addition, since layout processing is executed so as to cause respective container sizes to get close to the contents size as much as possible by using contents-prioritized layout algorithm, the contents-prioritized layout algorithm gives rise to an effect in the case where layout processing is intended by using a real size of the contents.

[Second Layout Algorithm (in Consideration of Basic Container Size and Contents Size)]

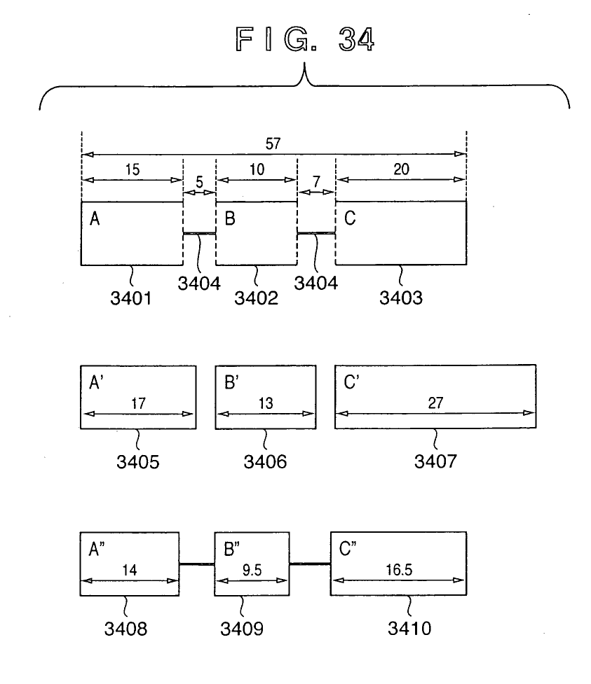

Subsequently, a second layout algorithm will be described with reference to FIG. 34. The initial conditions are the same as those in FIG. 32. Reference numerals 3401 to 3403 denote containers at the time of designing. Reference numerals 3405 to 3407 denote contents to be inserted to respective containers. Reference numeral 3404 denotes a link for associating respective containers and the link shall be a fixed link. In addition, reference numerals 3408 to 3410 denote layout calculation results calculated by applying the second layout algorithm to FIG. 34. In addition, the second layout algorithm refers to “contents-prioritized algorithm” since the basic container size and the contents size are considered.

At first, the reference size for calculating the second layout algorithm is a value subject to dividing by 2 the sum of sizes of respective containers and contents sizes inputted to respective containers.

Accordingly, the reference size for calculation in the container A is “16”, the reference size for calculation in the container B is “11.5” and the reference size for calculation in the container C is “23.5”. The method of calculating the tension of respective containers is:
T layout result size−{(contents size+basic container size)/2}| (11).

And, the total of tension T calculated for respective containers by using equation (11) will become the total tension of the present target set. This will be described with reference to FIG. 34.

Let a, b, and c be the container sizes after calculation. In order to distribute the tension generated in respective containers appropriately, it is desirable to implement calculation processing with:
t=(a−16)²+(b−11.5)²+(c−23.5)² (12).

Since the layout in FIG. 34 is a simple layout and no priority is set, the variable t is minimized when:
|a−16|=|b−11.5|=|c−23.5| (13).

The layout size after calculation can be given by:
a+5+b+7+c=57 (14).

The size of each container after calculation is obtained from equations (13) and (14) in case of consideration of contents and the basic container, deriving a=14, b=9.5 and C=16.5. Accordingly, after calculation, containers A″, B″, and C″ (3408 to 3410) have the sizes as shown in the drawing respectively.

Likewise the first layout algorithm, in case of such a layout as in FIG. 34, a layout result can be calculated without using the least-squares method. However, in case of applying the second layout algorithm to such a layout as in FIG. 33, it is desirable to use the least-squares method as well.

Since the calculation method in use of the least-squares method works by substituting the calculation result of {(contents size+basic container size)/2} to the reference size for calculation to implement processing like the contents-prioritized layout algorithm, detailed description will be omitted.

Since a layout result in consideration of both of the basic container size and the contents size can be calculated by using this second layout algorithm, intention of the author of a template and intention of the contents author can be reflected.

[Third Layout Algorithm (in Consideration of Container Size)]

In the present application, in addition to the above-described first and second algorithms, a third algorithm is provided. This third layout algorithm executes layout change so that the contents sizes inserted in the respective containers get close to the basic container size at the time of designing in the case where the first or the second layout algorithm is set to the container associated, with a link, by the container where the third layout algorithm is set. Therefore, the third algorithm refers to a basic design-prioritized layout algorithm. In the case where the third layout algorithm is set for all the containers included in one set, the contents size inserted in each container undergoes size change so as to match the basic container size. That is, even without implementing calculation processing such as the first layout algorithm or the second layout algorithm, calculation of a layout result is feasible. However, in the case where the third layout algorithm and another layout are set in one set, calculation processing will be required. This calculation processing will be described with reference to FIG. 33.

The initial conditions in FIG. 33 are described above and description thereon will be omitted. Here, let the first layout algorithm be set for the containers A and B and the third layout algorithm be set for the container C. Effectiveness in the case in use of the least-squares method has already been described above. Accordingly, in order to take advantage of that effectiveness, the case in use of the least-squares method will be focused in description.

The reference size for calculation on the containers A and B will be the contents sizes inserted in the respective containers (the reference size for calculation of the container A is 15 while the reference size for calculation of the container B is 25). On the other hand, since the third layout algorithm is set for the container C, the reference size for calculation will become the basic container size (the reference size for calculation of the container C is 9).

Consequently, an equation for calculating the variable t for distributing tension of respective containers to keep balance is described as follows:
t=(a−15)²+(b−25)²+(c−9)² (15)
When equations (6) and (7) are substituted into equation (15),
t=(a−15)²+{(−a+20)−25}²+{(a−1)−9}² (16).
When equation (16) undergoes differentiation with a due to the same reason as in case of equation (10),
0=2(a−15)−2(−a−5)+2(a−10)
a=6.7 (26).

Moreover, by using the calculation result and equations (6) and (7), b=13.3 and c=5.7 are derived.

Accordingly, by applying, for example, the contents-prioritized layout algorithm and the basic design prioritized layout algorithm, a layout result can be calculated so as to get close to the contents size and the basic container size on a container basis. That is, it will become possible to calculate a layout result in reflection of intention of a template author or a contents size author on a container basis.

Thus, the basic design prioritized layout algorithm is used in one set in combination with another layout algorithm and thereby gives rise to its effect.

[Example of Setting UI (1)]

FIGS. 25A to 25G are diagrams showing examples of a user interface (UI) for setting respective layout adjustment algorithms as described above.

In response to predetermined operation of a user, a dialog 2500 for specifying a range for applying the layout adjustment algorithm is displayed. The corresponding dialogs 2501 to 2541 are displayed according to what is selected in the dialog 2500.

When “Document” is selected in the dialog 2500 of FIG. 25F, a dialog 2501 is displayed for a user to select the layout adjustment algorithm to apply for each document in FIG. 25A. The user can select the layout adjustment algorithm for containers in the document by using the dialog 2501. The dialog 2501 has options including “Layout of Conentes priority” 2502, “Container-contents priority” 2503 and “Basic design priority” 2504. The user selects one from the options. The dialog 2501 does not have the option “Not designated”, which is shown in FIGS. 25B to 25E. That is because the layout adjustment algorithm to be used as a default value of the document needs to be decided. The layout adjustment algorithm to be used is decided according to the applied policy as described later, and here, “Not designated” is excluded from the options just for convenience. The layout adjustment algorithm selected in the dialog 2501 affects the entire document; however, whether the algorithm is applied to all the containers in the document at the actual layout calculation or not is determined according to the applied policy. The applied policy will be described in detail in “Order of Applied Policy” later.

When “Page” is selected in the dialog 2500, a page setting screen for specifying a page or a range of pages to which the algorithm is to be applied is displayed, a dialog 2511 is displayed for a user to select the layout adjustment algorithm to be applied for each page in FIG. 25B.

The user can select the layout adjustment algorithm for containers in a page by using the dialog 2511.

The dialog 2511 has options including “Not designated” 2512, “Container-contents priority” 2513, “Container-contents priority” 2514 and “Basic design priority” 2515. The user can select one from the options.

The layout adjustment algorithm selected in the dialog 2511 affects a page which is designated when the setting dialog is opened. In FIG. 25B, “Not designated” is selected.

Whether setting of the dialog 2511 is applied to all the containers in a page at the actual layout calculation or not depends on the applied policy to be described later.

When “Area” is selected in the dialog 2500, the dialog 2521 is displayed for a user to select the layout adjustment algorithm to be applied for each area in FIG. 25C. When the layout adjustment algorithm is selected for an area, the area needs to be designated on a document template displayed after the area, in the dialog 2500.

The user can select the layout adjustment algorithm for containers in an area by using the dialog 2521. The dialog 2521 has options including “Not designated” 2522, “Layout of Conentes priority” 2523, “Layout of Container-contents priority” 2524 and “Basic design priority” 2525. The user can select one from the options.

The layout adjustment algorithm selected in the dialog 2521 affects the containers in an area which is designated when the setting dialog is opened. In FIG. 25C, “Not designated” is selected. Whether setting of the dialog 2521 is applied to all the containers in an area at the actual layout calculation or not depends on the applied policy to be described later.

When “Record” is selected in the dialog 2500, a record selection screen for selecting a record is displayed. A dialog 2531 is selected for a user to select the layout adjustment algorithm to be applied for each record specified on the record selection screen in FIG. 25D. The user can select the layout adjustment algorithm for containers in a record by using the dialog 2531. The dialog 2531 has options including “Not Designated” 2532, “Layout of Conentes priority” 2533, “Layout of Container-contents priority” 2534 and “Basic design priority” 2535. The user can select one from the options. The layout adjustment algorithm selected in the dialog 2531 affects all the containers in a record which is designated when the setting dialog is opened.

In FIG. 25D, “Not designated” is selected. Whether it is applied to all the containers regarding to a record at the actual layout calculation depends on the applied policy.

When “Container” is selected in the dialog 2500, a container selection screen for selecting a container is displayed. The dialog 2541 is displayed for a user to select the layout adjustment algorithm to be applied for each container specified on the container selection screen in FIG. 25E. The user can select the layout adjustment algorithm for a certain container by using the dialog 2541. The dialog 2541 has options including “Not Designated” 2542, “Layout of Conentes priority” 2543, “Layout of Container-contents priority” 2544 and “Basic design priority” 2545. The user can select one from the options. The layout adjustment algorithm selected here affects the containers which are designated when the setting dialog is opened.

In FIG. 25E, “Not Designated” is selected. Whether the designated layout adjustment algorithm is applied to the containers at the actual layout calculation or not depends on the applied policy to be described later. In the case where a “group of containers” has been selected in the dialog 2500, a container group selection window for selecting a group of containers is displayed. In order to select a layout adjustment algorithm to be applied to each group of containers selected with the container group selection window, a dialog 2551 in FIG. 25G is displayed. Since selection processing and the like for the dialogue 2551 is equivalent to that described above, detailed description will be omitted. In addition, a group of containers refers to a set associated by links hereof.

As described above, the layout adjustment algorithms designated in FIGS. 25A to 25E are held in the memory 136, the storage device 139 or the like as the layout adjustment algorithm information indicating the layout adjustment algorithm set in each range such as a document, a page, an area, a record, a container or the like. Therefore, the layout editing application program can execute determination processing in a flowchart of FIG. 19 by referencing the memory 136 or the storage device 139.

When the layout adjustment algorithm is set by the UIs in the above-described FIGS. 25A to 25G, the layout adjustment algorithms set in a layer structure as shown in FIG. 30 are stored in the memory 136 or the storage device 139.

[Applied Policy]

The applied policy is applied in the order of document setting, page setting, record setting, area setting and container setting as described in the flow of parsing the applied layout adjustment algorithm (FIG. 19). That is to say, the smaller the unit to be applied with the layout adjustment algorithm, the higher the priority it is set, and in the higher priority it is used for the layout calculation. In the layer structure of FIG. 30, the lower the layer, the higher the priority of the set contents, and in the higher the priority it is used for the layout calculation.

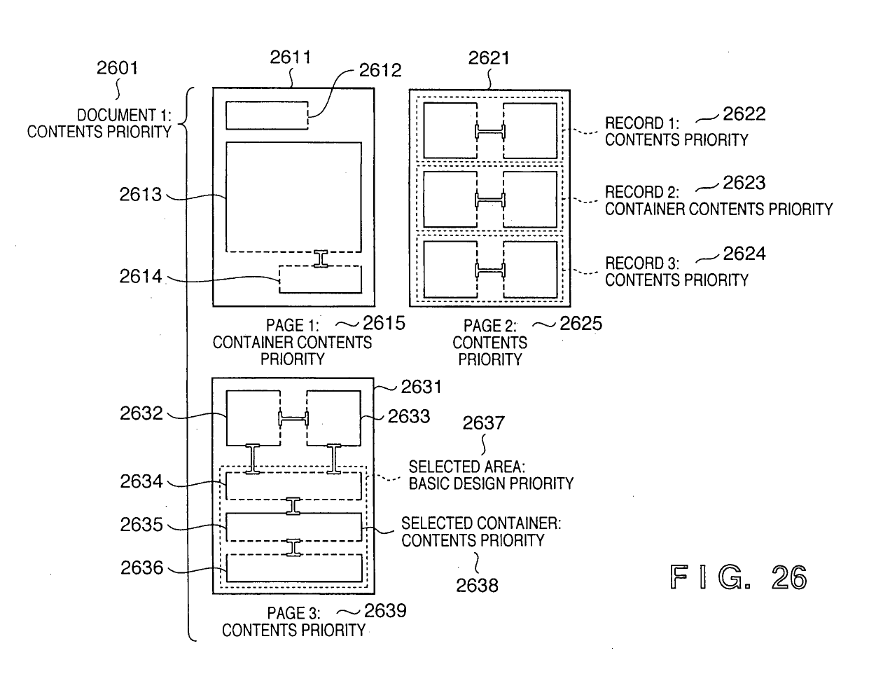

FIG. 26 shows how each container is finally set by the layout adjustment algorithm set by each unit in a certain document.

This setting can be obtained from a layer structure of FIG. 30. As shown in FIG. 30, “contents priority” is set for this document. Therefore, the layout adjustment algorithm of ‘contents priority’ is set as default for all the containers in the document.

Next, as a unit of the page, it is apparent from FIG. 30 that “container-contents priority” is set for the first page 2611 and “contents priority” is set for the second page 2621 and the third page 2631. As the layout calculation is not set by smaller unit in the first page 2611, the applied layout adjustment algorithm of all the containers (container 2612, container 2613, container 2614) in the first page are “contents priority”.

In the second page 2621, the layout adjustment algorithm is set for a plurality of records. The second page uses a multi-record function for inserting contents data of a plurality of records into one page. More specifically, contents data of the first record is inserted into a link set 2622 and contents data of the second record is inserted into a link set 2623 and contents data of the third record is inserted into a link set 2624 in the second page.

Then, “contents priority” is set for the link sets 2622 and 2624, to which the first and the third records are inserted respectively, and “container-contents priority” is set for the link set 2623.

The second page 2621 has no setting by unit smaller than the unit of record. Therefore, as “container-contents priority” is applied to all the containers in the link set 2623, “contents priority” is applied to all the containers in the link sets 2622 and 2624.

The third page 2631 has a selection area 2637 designated by a user, for which “basic design priority” is designated. The layout adjustment algorithm (“contents priority”) other than that designated for the selection area 2637 is directly set for the container 2635 in the selection area. Therefore, “basic design priority” is applied to the container 2634 and the container 2636 in the selection area 2637 and “contents priority” is applied to the container 2635. “Conentes priority (2639)” set for the third page 2631 is applied to the container 2632 and the container 2633 outside the selection area 2637 in the page.

As it is apparent from the description above, the layout adjustment algorithm set in downstream in FIG. 30 is preferentially applied.

[Example of Setting UI (2)]

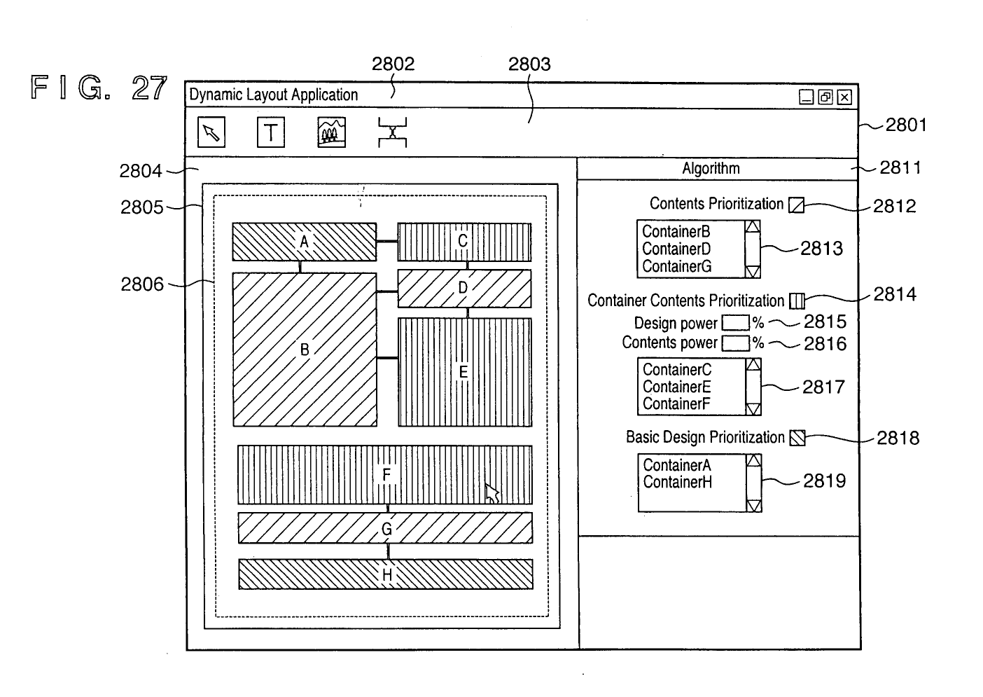

FIG. 27 is a diagram showing another example of a user interface for setting the layout adjustment algorithm. For example, the layout adjustment algorithm set for each container is obtained based on the algorithm information as shown in FIG. 30, and the layout adjustment algorithm set for each container is designated by using some kinds of shade as shown in FIG. 27. The layout adjustment algorithm set for each container is apparent with such UIs, and the layout adjustment algorithm for each container is easily designated.

In a typical window 2801 with a title bar 2802 and a tool bar 2803, the main window 2804 displays a page 2805 and containers laid out in the page. The main window 2804 also displays the lines indicating a margin area 2806 in the page. The main window 2804 also displays a pallet 2811, which enables a user to designate the layout adjustment algorithm for containers on the main window. For example, if a user wants to apply the layout adjustment algorithm of contents priority to a container B, the user drags and drops a mark 2812 into the container B. Similarly, a mark 2814 is used for the layout adjustment algorithm of container-contents priority and a mark 2818 is used for the layout adjustment algorithm of basic design priority. The containers are displayed in different shades according to the kind of the layout adjustment algorithm set for respective containers. That helps a user in easily recognizing the layout adjustment algorithm used by each container.

A user can also set the layout adjustment algorithm by designating the area. For example, when the user draws a rectangular only including containers C, D and E on the UI by using a mouse, the containers C, D and E are selected. Then, the user drags and drops the marks (2812, 2814, 2818) corresponding to a desired layout adjustment algorithm into any of the selected containers. In this manner, the user has collectively set the layout adjustment algorithms to all the containers in the selected area. In response to the user's designation of areas, the part of the areas in a layer structure of FIG. 30 is changed according to the changed structure. A frame of an area in which containers belonging to an area is included is released when a user designates the layout adjustment algorithm for the containers or when a user designates an area for the containers as it belongs to another area.

In the UI of FIG. 27, the containers, for which the layout adjustment algorithm of contents priority are designated, are listed in a list box 2813. The containers, for which the layout adjustment algorithm of container-contents priority are designated, are listed in a list box 2817 and the containers, for which the layout adjustment algorithm of basic design priority are designated, are listed in a list box 2819. The layout adjustment algorithm of container-contents priority has an edit box for a user to input a design power 2815 and a contents power 2816, which will be described in detail in “Algorithm Priority” later. A user can easily decide the layout adjustment algorithm for each container by viewing such a screen.

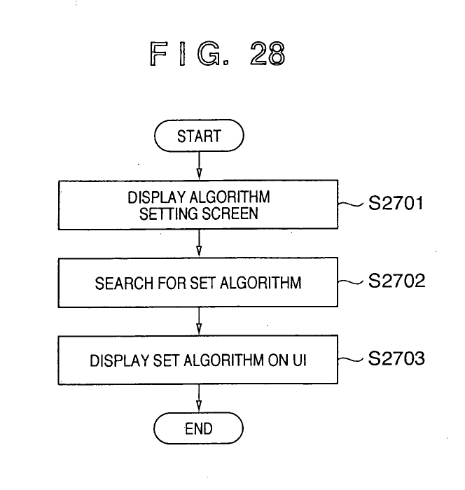

FIG. 28 is a flowchart showing processing for displaying the UI of FIG. 27. First, in step S2701, the layout editing application program 121 recognizes a user's indication to display the layout adjustment algorithm setting screen and displays the layout adjustment algorithm setting screen as shown in FIG. 27.

Next, the layout editing application program 121 searches for the layout adjustment algorithm set for each container (S2702). Specifically, as layer information shown in FIG. 30 is held in the memory 136 or the like, the layout editing application program 121 can execute processing of S2702 by referencing the memory 136.

In step S2703, the layout editing application program 121 shades the containers and displays them into the lists 2813, 2817 and 2819 respectively based on the respective layout adjustment algorithms set for the containers. In this manner, an interface as shown in FIG. 27 has been displayed. Information on the layout adjustment algorithm set for each container by using the UIs of FIG. 27 are held in the memory 136, the storage device 139 or the like as algorithm information.

[Algorithm Priority]

The layout adjustment algorithm of container-contents priority derives a layout result by reducing a tension from the current container size and the container size at being designed (design size) as well as a difference between the current container size and the contents size. Then, the algorithm can determine whether the contents size or the design size the containers should be laid out near by setting a weight value to respective tensions.

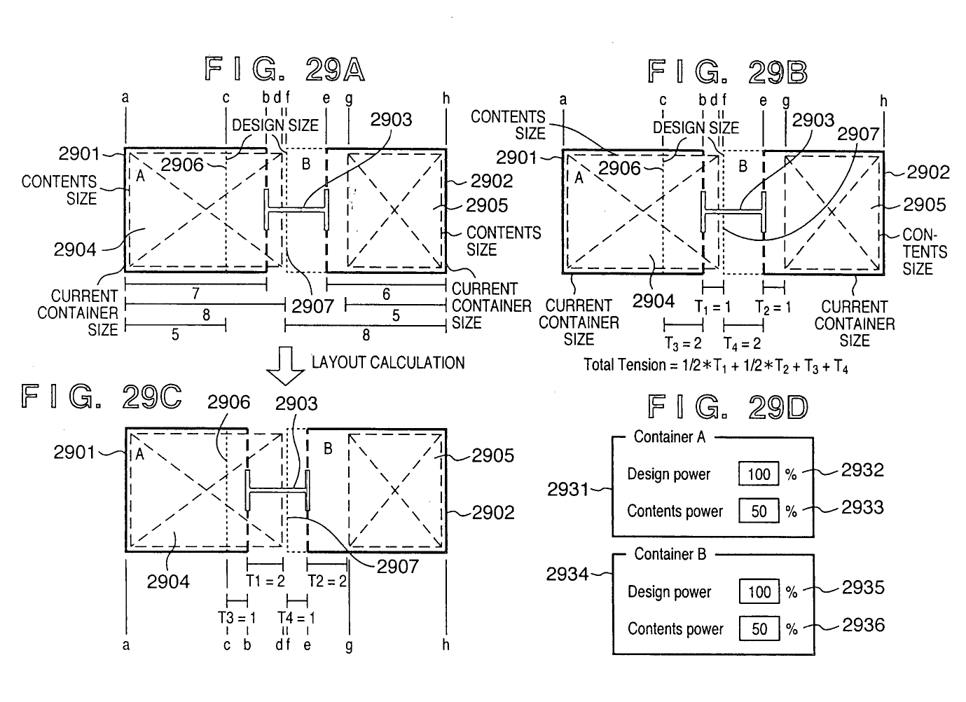

FIGS. 29A to 29D describe how the layout calculation is executed with the priority being set, when a layout adjustment algorithm of container-contents priority is applied to the container 2901 and the container 2902.

As shown in FIG. 29A, the container 2901 and the container 2902 are present and associated with each other by a link 2903. Each container has data (contents) inserted from database such that the contents 2904 is inserted into the container 2901 and the contents 2905 is inserted into the container 2902.

The width sizes of the current containers are; |a−b|=7 for the container 2901 and |e−h|=6 for the container 2102. The width sizes in contents sizes are; |a−d|=8 for the contents 2904 and |g−h|=5 for the contents 2905. The container sizes 2906 and 2907 at being designed are also present.

“container-contents priority” is set for the container 2901 and the container 2902. Accordingly, in the layout calculation, a difference (tension T₁) between the current container size (container 2901) and the contents size (contents 2904) and a difference (tension T₃) between the current container size (container 2901) and the design size (design size 2906) are used.

As “container-contents priority” is set for the container 2902, a difference (tension T₂) between the current container size (container 2902) and the contents size (contents 2905) and a difference (tension T₄) between the current container size (container 2902) and the design size (design size 2907) are used. The layout calculation brings the current container near to the reference size for calculation by reducing the sums of the tensions and executing the layout adjustment on the current container.

FIG. 29B shows a state where the calculation of the tensions is executed. As a tension of the container 2901, a tension T₁ (=|b−d|=1) between the current container size (7) and the contents size (8) and a tension T₃ (=|b−c|=2) between the current container size (7) and the design size (5) are present.

The container 2902 has a tension T₂ (=|e−g|=1) between the current container size (6) and the contents size (5) and a tension T₄ (=|f−e|=2) between the design size (8) and the current container size (6).

As shown in FIG. 29D, a design power and a contents power can be set in the layout adjustment algorithm of container-contents priority set for a container A and a container B in a property 2931 and the property 2934, respectively. The term “power” here means a weight value and is a power for approaching a certain size. For example, the “power” means a power for approaching the design size or a power for approaching the contents size. Here, it is assumed that a usual power (weight value) is 100%. If the value is higher than 100%, the power increases, thus, the power for approaching the size increases. In contrast, if the value is lower the value, the power decreases, this, the power for approaching the size decreases. Those are implemented correspondingly to a tension in the layout calculation. That is to say, the algorithm executes the layout adjustment on the container by changing a ratio of tension on the basis of the value of the power (weight value).

In each of the property, the design power 2932 is set to 100% and the contents power 2933 is set to 50% in the container A and the design power 2935 is set to 100% and the contents power 2936 is set to 50% also in the container B. That is to say, in the link sets of FIGS. 29A to 29D, a power for bringing the container size near to the design size at the basic layout creation is twice as bigger as the power for bringing it near to the contents size.

Therefore, the sum of the tensions of the link set is 1/2×(T₁+T₂)+T₃+T₄=1/2×(|b−d|+|e−g|)+|b−c|+|f−e|=1/2×2+2+2=5.

FIG. 29C shows a result of moving marks to reduce the tension which is calculated in this manner. In FIG. 29C, the size of the container 2901 is |a−b|=6 and the size of the container 2902 is |e−h|=7. Therefore, a tension at the layout result is 1/2×(T₁+T₂)+T₃+T₄=1/2*(|b−d|+|e−g|)+|b−c|+|f−e|=1/2*4+1+1=4. Although the state of tension 0 is not achieved in this case, the layout calculation is ended here as it cannot further reduce the tension.

As described above, in the above example, the container A and the container B are laid out somewhat nearer to the design size than to the contents size. The embodiment can serve various needs from a user in the layout by applying priority (also referred to as power or a weight value) to the layout adjustment algorithms.

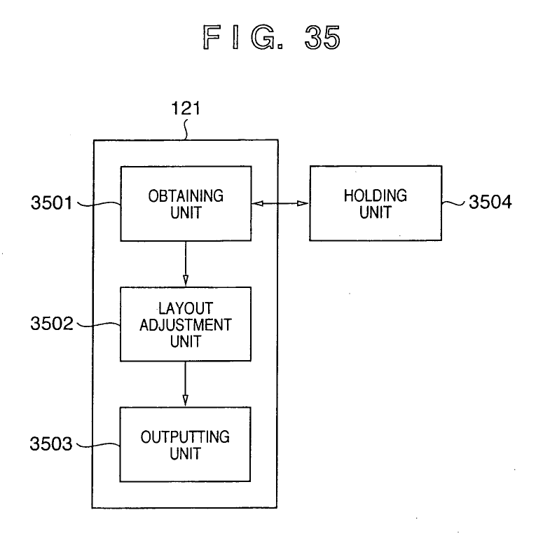

An arrangement of functions of the above-described automatic layout system (layout editing application program 121) can be shown as FIG. 35, for example. In FIG. 35, the layout editing application program 121 executes layout processing for dynamically changing the layout of the template including a data area according to the contents data drawn in the data area. In order to execute the layout processing, an obtaining unit obtains the layout adjustment algorithm to be applied to the data area from a holding unit which holds a plurality of layout adjustment algorithms to be applied to the data area. A layout adjustment unit adjusts the layout of the data area according to the layout adjustment algorithm obtained at the obtaining unit when the layout adjustment unit inserts contents data into the data area. Then, the outputting unit lays out contents data and outputs the contents data to the data area which is adjusted at the layout adjustment unit.

As described above, according to the embodiment, the automatic layout system can set the layout adjustment algorithm of various layout calculation methods to each container. Accordingly, even if a plurality of containers are associated with each other and the containers change the layout as affecting each other, the embodiment can create various layouts intended by a user by executing the size calculation with the layout adjustment algorithm desired by the user for each container. Further, as the set layout adjustment algorithm can be visually shown, a user can easily predict the layout result after subjected to the automatic layout.

In the above-described embodiment, many kinds of calculation method algorithms are for executing the layout adjustment on a data area so as to reduce a difference between the data area and a target form. A process of calculating the difference differs for each layout adjustment algorithm. That enables the layout adjustment to reflect the user's intention. When the layout adjustment is executed on a plurality of containers associated with each other, the embodiment only needs to execute the layout adjustment on the container so as to reduce the sum of differences (tensions) obtained by applying each layout adjustment algorithm. Therefore, the embodiment is easily applied to negotiation processing among a plurality of containers.

The object of the present invention can also be achieved by supplying a storage medium (or recording medium) which stores software program codes for implementing the functions of the above-described embodiment to a system or apparatus and causing the computer (or a CPU or MPU) of the system or apparatus to read out and execute the program codes stored in the storage medium.

In this case, the program codes read out from the storage medium implement the functions of the above-described embodiment by themselves, and the storage medium which stores the program codes constitutes the present invention. The functions of the above-described embodiment are implemented not only when the readout program codes are executed by the computer but also when the operating system (OS) running on the computer performs part or all of actual processing on the basis of the instructions of the program codes.

The functions of the above-described embodiment are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

The present invention is also achieved when software program codes for implementing the functions of the above-described embodiment are distributed through a network and stored in a storage means such as a hard disk or memory of a system or apparatus or a storage medium such as a CD-RW or CD-R, and the computer (or CPU or MPU) of the system or apparatus reads out and executes the program codes stored in the storage means or storage medium.

The present invention enables an output result desired by a user to be obtained even in variable print which deals with various contents data, as the present invention adjusts contents data in a data area by using the layout adjustment algorithm to be applied from a plurality of layout adjustment algorithms.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-061063, filed on Mar. 4, 2005, and No. 2006-048014, filed on Feb. 24, 2006, which are hereby incorporated by reference herein in their entirety.

What is claimed is:

1. A layout processing method for changing dynamically a layout of a template including a data area according to contents data to be drawn in the data area, comprising:
a selecting step of selecting a layout adjustment algorithm to be applied to said data area from a plurality of layout adjustment algorithms;
a layout adjusting step of adjusting a layout of said data area according to the layout adjustment algorithm selected in said selecting step in inserting contents data into the data area; and
an outputting step of laying out said contents data and outputting the contents data according to the data area adjusted in said layout adjusting step.

2. The method according to claim 1, wherein each of said plurality of layout adjustment algorithms is for adjusting a layout of the data area so as to reduce a difference between the data area and a target form, and wherein a process of calculating said difference differs for each layout adjustment algorithm.

3. The method according to claim 2, wherein, said layout adjusting step calculates said difference according to the layout adjustment algorithm selected in said selecting step for each of a plurality of data areas being associated with each other, and adjusts a layout of each of said plurality of data areas being associated with each other so as to minimize the sum of the calculated differences in adjusting each layout of said plurality of data areas being associated with each other.

4. The method according to claim 2, wherein said plurality of layout adjustment algorithms comprise at least two of:
a first algorithm for calculating said difference by using a contents form complying with contents data to be drawn in a data area as said target form;
a second algorithm for calculating said difference by using a layout form which is a form of a data area at said layout design, as said target form; and
a third algorithm for using the sum of a first difference, which is a difference between a data area and said contents form, and a second difference, which is a difference between the data area and said layout form, as a difference between said data area and a target form.

5. The method according to claim 4, said layout adjusting step uses the sum of the first difference, which is a difference between said data area and said contents form, and the second difference, which is a difference between the data area and said layout form, as a difference from a target form in adjusting a layout of a data area with said third algorithm.

6. The method according to claim 5, said layout adjusting step adjusts a layout of a data area according to a weight value to be set for each of said first difference and said second difference.

7. The method according to claim 1, further comprising a presenting step of presenting a user interface for a user to set a layout adjustment algorithm in a data area, wherein the layout adjustment algorithm set for said data area is held in said holding means according to what is inputted via said user interface presented in said presenting step.

8. The method according to claim 7, wherein said user interface can designate a layout adjustment algorithm by a predetermined range, and wherein said layout adjustment algorithm is set by a predetermined range, which includes a document, a page forming the document, an area included in the page, and a data area.

9. The method according to claim 8, wherein said selecting step selects a layout adjustment algorithm to be applied to said data area according to an order of precedence for each of said predetermined ranges.

10. The method according to claim 7, wherein said user interface has functions of displaying a layout state of a data area on a page and letting a user to set a desired layout adjustment algorithm for the data area designated from the displayed data areas.

11. The method according to claim 7, wherein said user interface visually displays the layout editing algorithm set for the data area to the user.

12. The method according to claim 1, further comprising a setting step which enables a user to set any layout adjustment algorithm for each data area.

13. An information processing apparatus for changing dynamically a layout of a template including a data area according to contents data to be drawn in the data area, comprising:
an obtaining unit configured to obtain a layout adjustment algorithm to be applied to said data area from a holding unit, which holds a plurality of layout adjustment algorithms to be applied to said data area;
a layout adjusting unit configured to adjust a layout of said data area according to the layout adjustment algorithm obtained by said obtaining unit in inserting contents data into the data area; and
an outputting unit configured to lay out said contents data and output the contents data according to the data area adjusted by said layout adjusting unit.

14. The apparatus according to claim 13, wherein each of said plurality of layout adjustment algorithms is for adjusting a layout of the data area so as to reduce a difference between the data area and a target form, and wherein a process of calculating said difference differs for each layout adjustment algorithm.

15. The apparatus according to claim 14, wherein, said layout adjusting unit calculates said difference according to the layout adjustment algorithm obtained by said obtaining unit for each of a plurality of data areas being associated with each other, and adjusts a layout of each of said plurality of data areas being associated with each other so as to minimize the sum of the calculated differences in adjusting each layout of said plurality of data areas being associated with the link.

16. The apparatus according to claim 14, wherein said plurality of layout adjustment algorithms comprise at least two of:
a first algorithm for calculating said difference by using a contents form complying with contents data to be drawn in a data area as said target form;
a second algorithm for calculating said difference by using a layout form which is a form of a data area at said layout design, as said target form; and
a third algorithm for using the sum of a first difference, which is a difference between a data area and said contents form, and a second difference, which is a difference between the data area and said layout form, as a difference between said data area and a target form.

17. The apparatus according to claim 16, said layout adjusting means use the sum of the first difference, which is a difference between said data area and said contents form, and the second difference, which is a difference between the data area and said layout form, as a difference from a target form in adjusting a layout of a data area with said third algorithm.

18. The apparatus according to claim 17, said layout adjusting unit adjusts a layout of a data area according to a weight value to be set for each of said first difference and said second difference.

19. The apparatus according to claim 13, further comprising a presenting unit configured to present a user interface for a user to set a layout adjustment algorithm in a data area, wherein the layout adjustment algorithm set for said data area is held in said holding unit according to what is inputted via said user interface presented by said presenting unit.

20. The apparatus according to claim 19, wherein said user interface can designate a layout adjustment algorithm by a predetermined range, and wherein said layout adjustment algorithm is set by a predetermined range, which includes a document, a page forming the document, an area included in the page, and a data area.

21. The apparatus according to claim 20, wherein said obtaining unit obtains a layout adjustment algorithm to be applied to said data area according to an order of precedence for each of said predetermined ranges.

22. The apparatus according to claim 19, wherein said user interface has functions of displaying a layout state of a data area on a page and letting a user to set a desired layout adjustment algorithm for the data area designated from the displayed data areas.

23. The apparatus according to claim 19, wherein said user interface visually displays the layout editing algorithm set for the data area to the user.

24. The apparatus according to claim 13, further comprising a setting unit which enables a user to set any layout adjustment algorithm for each data area.

25. A computer program causing a computer to execute the layout processing method according to claim 1.

26. A computer readable medium storing a program causing a computer to execute the layout processing method according to claim 1.
